(19) United States
(12) Patent Application Publication
(10) Pub. No.: US 2021/0224934 A1
(43) Pub. Date: Jul. 22, 2021

(54) Residence Provisioning Platform

(71) Applicant: State Farm Mutual Automobile Insurance Company, Bloomington, IL (US)

(72) Inventors: Aaron Williams, Congerville, IL (US); Brian Mark Fields, Normal, IL (US); Jacob J. Alt, Downs, IL (US); Brian Dzik, Bloomington, IL (US); Dwight Powell, Normal, IL (US); Lewis Donley, Normal, IL (US); John A Schirano, Bloomington, IL (US); Edward P Matesevac, III, Normal, IL (US); Kathy Curry, Mesa, AZ (US)

(73) Assignee: State Farm Mutual Automobile Insurance Company, Bloomington, IL (US)

(21) Appl. No.: 16/170,291

(22) Filed: Oct. 25, 2018

Related U.S. Application Data
(60) Provisional application No. 62/646,637, filed on Mar. 22, 2018.
(60) Provisional application No. 62/639,201, filed on Mar. 6, 2018.
(60) Provisional application No. 62/618,955, filed on Jan. 18, 2018.
(60) Provisional application No. 62/617,824, filed on Jan. 16, 2018.
(60) Provisional application No. 62/599,103, filed on Dec. 15, 2017.

(51) Int. Cl. G06Q 50/16; G06Q 10/10; G06Q 20/06; G06Q 30/02; G06N 99/00

(52) U.S. Cl. CPC G06Q 50/167; G06Q 10/1093; G06Q 20/065; G06K 19/06037; G06Q 30/0202; G06N 99/005; G06Q 30/0206

(57) ABSTRACT

Systems and methods are described for provisioning physical residences to and from users of a residential provisioning platform. The residential provisioning platform assigns a platform unit value to each of a plurality of physical residences. A residence provisioning app is provided to a user for implementation on the user's device and for displaying selections corresponding to the plurality of physical residences. The residential provisioning platform may include a residence tracking app that receives a user selection from the residence provisioning app corresponding to a particular physical residence, updates a particular residence dossier of the particular physical residence to assign the particular physical residence to the user, and updates a residence profile of the user to indicate a remaining platform unit value of the particular physical residence attributable to the user. The residence tracking app transmits a digital access pass to the provisioning app allowing access to the particular physical residence.

### RELATED APPLICATIONS

This application claims the benefit of U.S. Provisional Application No. 62/599,103 (filed on Dec. 15, 2017); U.S. Provisional Application No. 62/617,824 (filed on Jan. 16, 2018); U.S. Provisional Application No. 62/618,955 (filed on Jan. 18, 2018); U.S. Provisional Application No. 62/639,201 (filed on Mar. 6, 2018); and, U.S. Provisional Application No. 62/646,637 (filed on Mar. 22, 2018). The entirety of each of the foregoing provisional applications is incorporated by reference herein.

### FIELD OF THE DISCLOSURE

The present disclosure generally relates to systems and methods regarding residence provisioning, and, more particularly, to provisioning physical residences to users of a residential provisioning platform, the residential provisioning platform assigning platform unit values to each of a plurality of physical residences.

### BACKGROUND

Conventional methods for locating, purchasing, and/or securing access to residences may typically require an individual to utilize multifaceted services, which may be often associated with disassociated entities or platforms. This may leave the individual not only frustrated, but also effectively tied to a residence because of, e.g., poor market conditions, lack of perceived options, high costs, etc.

For example, an individual seeking to relocate to a new residence in a different geographic location may typically start by contacting a realtor, or by reviewing residences on a 3^{rd} party platform (e.g., Zillow). After the individual finds one or several suitable residences, the individual may then secure financing via a bank or other lender, which may include analyzing websites or other resources to compare mortgage interest rates, APRs, and/or other technical or financial information. In addition, the individual may plan his or her own relocating services to move to a new residence and must secure access to the residence, either by receiving, or by having new keys made, to access the residence. All of these various disassociated platforms and services may take weeks or months to accomplish, and at great expense to the individual.

In addition, with typical residence ownership, individuals may often be tied to a 30-year contract which anchors them to debt and a specific residence in a specific location for that term. These individuals may also be tied to closing costs, three decades worth of interest to a bank, taxes, and/or costs of ownership. In addition, in the course of 30 years, situational and geographic conflicts may arise—such as a growing and decreasing family size (and dependence on larger or smaller residences, respectively), job opportunities and job losses in different locations, health and age-related needs in different locations, etc. Each of these situations or geographic conflicts may cause an individual having ownership in a residence to sell his or her residence quickly, which may result in the loss of equity, profit, and/or additional resources.

In addition, in more modern times, younger individuals may be foregoing residences—such as due to the expense and hassle associated with typical residence acquisition and ownership. This may be due to increased student loan debt, lack of job opportunities, new life/work balance beliefs, and/or the desire to be mobile should life or work opportunities arise in different geographic locations. Such younger individuals may not want to be tied down to a specific residence that they may not be able to afford in an area, and/or that they may not want to live in, and with responsibilities they may not want.

### BRIEF SUMMARY

The present embodiments relate to a residential provisioning platform that may facilitate provisioning a plurality of physical residences to and from users of the residential provisioning platform. The residential provisioning platform described herein may disrupt traditional mortgage, homeownership, and renter industries. In various embodiments, the residential provisioning platform may include a stakeholder that acquires residences (e.g., houses, apartments, duplexes, condos, and other types of dwellings throughout the nation).

Users of the residential provisioning platform may gain access to the residences via platform units. For example, as described in embodiments herein, the users may access a residential providing app to obtain platform units and/or digital access passes that allow access to residences of the residential provisioning platform. This may provide the users of the residential provisioning platform to move freely between any available residences of the residential provisioning platform whenever they choose. Typical users may include existing homeowners, renters, and/or students across various age groups and generations.

The residential provisioning platform may provide several benefits to users, including security, affordability, providing homes that meets user needs, helping owners maintain equity in physical residences, and/or providing owners the freedom to transition between residences seamlessly, avoiding issues with traditional residence acquisition (e.g., as long-term contracts which tie the person to debt, interest payments, taxes, home maintenance, home style, and location). In addition, because the residential provisioning platform may be administered by a stakeholder entity, the stakeholder entity may maintain, service, or otherwise provide unique benefits to the users of the residential provisioning platform.

Accordingly, as described in various embodiments herein, residential provisioning systems and methods for provisioning physical residences to and from users of a residential provisioning platform may be provided. The residential provisioning platform may assign a platform unit value (or other type of share value) to each of a plurality of physical residences. The platform unit value may be a type of equity unique to the residential provisioning platform, and that may be bought, sold, and transferred as property rights. Users own the platform units and may be able to move freely to homes that are valued to their designated number of platform unit or below anytime they wish to any geographic location which is available nationally, or otherwise within the system.

The stakeholder may manage the platform unit value via a tracking app, as described herein, where the stakeholder may determine the platform unit value assigned to each physical residence and attributable to each user. A residence provisioning app may be provided to a user for implementation on a user device of the user. The residence provisioning app may be implemented on the user device to display selections corresponding to the plurality of physical residences.

The residential provisioning platform may include a residence tracking app executing on one or more server(s). The server(s) may store a residence dossier for each of the plurality of physical residences, where each residence dossier may include a physical residence address and a physical residence platform unit value. In various embodiments, the residence tracking app may receive a user selection from the residence provisioning app corresponding to a particular physical residence; update a particular residence dossier of the particular physical residence to assign to the particular physical residence to the user; and/or update a residence profile of the user to indicate a remaining platform unit value of the particular physical residence attributable to the user. In some embodiments, the residence tracking app may transmit a digital access pass to the provisioning app. The digital access pass may allow access to the particular physical residence.

In various embodiments, the residence provisioning platform provides a one-click, painless moving experience, where users may transfer residences with a single transfer command as described herein. In further embodiments, the residence provisioning platform may generate an electronic schedule to schedule a national moving service provided as a value-added option to users of the residence provisioning platform. This moving service may box, ship, and unload at the new location.

In still further embodiments, the residence provisioning platform may also, via the stakeholder, maintain and service the physical residences of the provisioning platform, thereby preventing major repairs or damage, and thus maintaining or increasing the value of the physical residence. The residence provisioning platform may track the maintenance history of a physical residence, and its maintenance, in order to schedule routine repair or review services.

The residence provisioning platform may also provide various benefits to the stakeholder of the residence provisioning platform, including revenue and data acquisition (e.g., relating to the users interaction with the provisioning platform), product-line diversity (e.g., the stakeholder being able to provide or contract a multitude of services), and an ability to interact with next generation consumers.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates an exemplary residential provisioning platform in accordance with various aspects described herein;

FIG. 2 illustrates an exemplary embodiment of a selection menu of a residence provisioning application implemented on a user device and displaying selections corresponding to a plurality of physical residences in accordance with certain aspects disclosed herein;

FIG. 3 illustrates an exemplary embodiment of a physical residence access of the residence provisioning application of FIG. 2 that depicts a digital access pass in accordance with certain aspects disclosed herein.

FIG. 4 illustrates an exemplary embodiment of a residence transfer menu of the residence provisioning application of FIG. 2 that depicts a visualization of a residence profile of a user in accordance with certain aspects disclosed herein:

FIG. 5 illustrates an exemplary computer-implemented method for provisioning a particular physical residence from a second user of a residential provisioning platform to a first user of the residential provisioning platform; and

FIGS. 6 and 7 depict exemplary computer-implemented methods of using residence shares to allow residents to move efficiently from one residence to another, and still maintain some equity or ownership interest by having the equity or ownership interest transfer from one residence to another via a residence share mechanism.

FIG. 8 depicts an exemplary computer-implemented method for assigning projected home values to a plurality of corresponding physical residences and providing the plurality of physical residences via a residence provisioning platform for selection by a user of the residence provisioning platform.

The Figures depict preferred embodiments for purposes of illustration only. Alternative embodiments of the systems and methods illustrated herein may be employed without departing from the principles of the invention described herein.

### DETAILED DESCRIPTION

The present embodiments relate to, inter alia, a residential provisioning platform that may facilitate provisioning a plurality of physical residences to and from users of the residential provisioning platform. The residential provisioning platform may provide several benefits to users, including security, affordability, providing homes that meets user needs, helping owners maintain equity in physical residences, and providing owners the freedom to transition between residences seamlessly, avoiding issues with traditional residence acquisition.

### Exemplary Residential Provisioning Platform

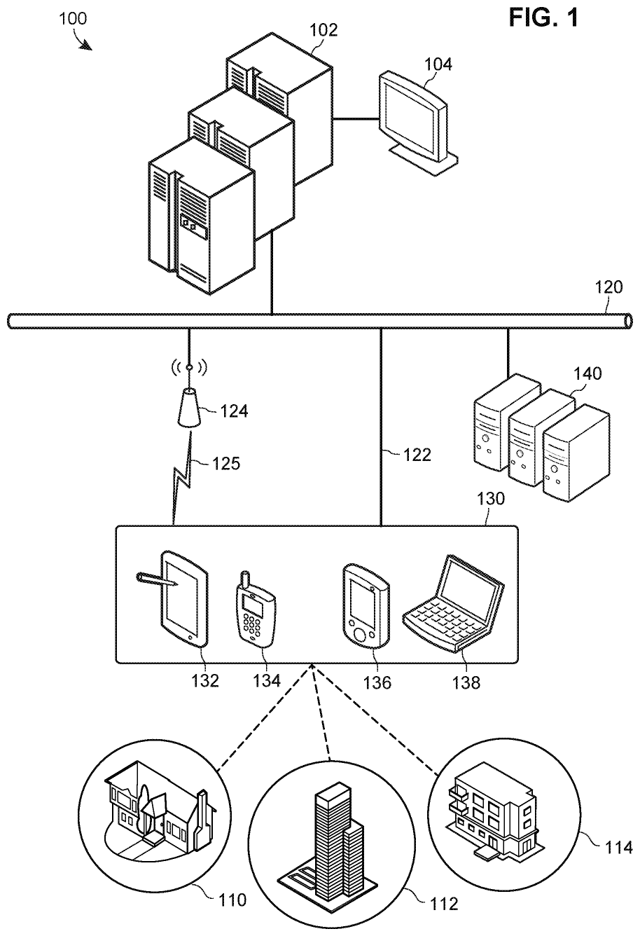

FIG. 1 illustrates an exemplary residential provisioning platform 100 in accordance with various aspects described herein. As shown in the embodiment of FIG. 1, provisioning platform 100 may include one or more residence tracking server(s) 102. Each of the servers of residence tracking server(s) 102 may be configured in a redundant fashion to receive and send data messages (e.g., with a residence tracking app) over computer network 120 as described herein. The residence tracking server(s) 102 may include one or more microprocessors executing a residence tracking application (app) implemented on residence tracking server(s) 102 as described herein. The residence tracking server(s) 102 may also include a local terminal 104 to provide administrative access to the residential provisioning platform 100, for example, by a stakeholder of the residential provisioning platform 100.

The residence tracking server(s) 102 may also include one or more memories (e.g., RAM or ROM type memories). The one or more memories may store residence dossiers of each of a plurality of physical residences as described herein. For example, as shown in FIG. 1, residence dossiers may be associated with each of the example physical residences 110, 112, and 114. Each of the physical residences 110, 112, and 114 may correspond to geographically distributed residences that are provisioned by the residential provisioning platform 100 as described herein. Moreover, each of the residence dossiers may include information of a particular physical residence (e.g., any of physical residences 110, 112, and 114), which may include, for example, a physical residence address, details of the physical residence (e.g., its square footage and number of bedrooms and baths), and a physical residence platform unit value of the particular physical residence.

The one or more memories of the residence tracking server(s) 102 may also store one or more residence profiles associated with users of the residential provisioning platform 100. Users of the residential provisioning platform 100 may receive a residence provisioning app to access the plurality of physical residences, as described herein. For example, as shown in the embodiment of FIG. 1, a user may receive and utilize a residence provisioning app via a user device 130. A user device may include any of a tablet 132, a mobile phone 134, a smart phone 136, a laptop 138, or any other such computer or electronic user device.

A user device 130 may be communicatively coupled to the residence tracking server(s) 102 via a computer network 120. The computer network 120 may be a private network or a public network, such as the Internet. The user device 130 may be connected to the computer network 120 via a wired connection 122, such as via an Ethernet-based cable. The user device 130 may also be connected to the computer network 120 via a wireless connection 125 in communication with a wireless transceiver 124, where the user device 130 and wireless transceiver 124 communicate via any of the 802.11 (Wi-Fi) standard, Bluetooth standard, or cellular phone standards (e.g., GSM, CDMA, LTE, etc.). The wireless transceiver 124 may be a Wi-Fi wireless router, Bluetooth standard transceiver, or cell-tower base station, respectively.

The residence provisioning platform and/or residence tracking app may be implemented in a variety of software architectures, including, for example, Java Enterprise Edition (JEE) which may, among other things, expose a Java application programming interface (API) for Representational State Transfer (RESTful) web services. The RESTful web services API may expose several web facing services, accessible via computer network 120, by residence provisioning app. The JEE platform may also implement dynamic webpage generation services, for example, Java Servlets, Java Server Faces (JSF), etc. for generating dynamic webpages (HTML, CSS, and/or JavaScript based webpages), which may include an embodiment of the residence provisioning app as described herein. While JEE is provided as an exemplary software architecture for implementation of various embodiments of the residence provisioning platform, other software architectures are contemplated herein. For example, persons of ordinary skill in the art would recognize that similar software architects, such as Microsoft.NET, Ruby on Rails, Node.js, etc., may also be used.

In some embodiments, the residence provisioning app, as provided to user devices 130, may be implemented via a mobile platform, such as Apple iOS or Google Android. In such instances, a user may download the residence provisioning app via the appropriate platform (e.g., Apple App store or Google Play) based upon the user's user device 130 operating system type, e.g., iOS or Android, respectively. In other embodiments, the residence provisioning app may be implemented via a webpage generated by the residence tracking server(s) 102, such as a JEE Servlet or JSF based webpage, and sent to the user's user device 130 (e.g., laptop 138). In either embodiment, the residence provisioning app may access the API of the residence tracking app, for example, via the RESTful API, in order to submit commands (e.g., transfer commands) and receive data and signals (e.g., selections corresponding to the plurality of physical residences, digital access passes, etc.) as described herein.

The residence tracking server(s) 102, the residence tracking app, and/or the residence provisioning app may each access a one or more third-party server(s) 140. The third-party servers may be operated by third-party companies that provide services (e.g., moving and/or maintenance services) with respect to the physical residences (e.g., physical residences 110-114) of the residential provisioning platform 100 as described herein. Each of the third-party server(s) 140 may include one or more microprocessors and one or more memories for receiving requests from, and transmitting responses to, any of: the residence tracking server(s) 102, the residence tracking app, and/or the residence provisioning app, which may be for scheduling, or other needs as described herein.

In some embodiments, the residence tracking server(s) 102 of the residential provisioning platform may be configured to provision a physical residence (e.g., physical residence 110) to a user of the residential provisioning platform. The residential provisioning platform may assign a platform unit value to each of a plurality of physical residences (e.g., each of physical residences 110-114). In some embodiments, residential provisioning platform may use a residence machine learning model to assign the platform unit values to the physical residences. For example, the residence machine learning model may be trained with residence feature and label training data that includes purchase prices, sizes, numbers or beds and baths, etc. of residences within a particular geographic location. The residence machine learning model may be trained using a variety of techniques including neural networks, decision trees, regression, etc. in order to determine platform unit values based upon the features of the various physical residences. In some embodiments, deep learning, combined learning, and/or reinforced learning programs, algorithms, and/or techniques may be used.

A stakeholder of the residential provisioning platform may then use the machine learning model to buy and sell physical residences making them available to users of the platform. For example, in various embodiments, the platform unit values may be distributed by a stakeholder of the residential provision platform. The stakeholder holder may be an owner or operator that administers the residential provisioning platform for its user. Moreover, the plurality of physical residences may be owned by the stakeholder associated with the residential provisioning platform in order to facilitate the transfer, maintenance, and other service of the plurality of physical residences (e.g., physical residences 110-114) as described herein. A residence provisioning app may be provided to the user for implementation on a user device (e.g., a user device 130) of the user. The residence provisioning app be implemented on the user device 130, for example, as an Apple iOS or Google Android based mobile app, to display selections corresponding to the plurality of physical residences (e.g., any one or more of physical residences 110-114).

In various embodiments, the residence tracking server(s) 102 may implement the residence tracking app, which may include, for example, a RESTful API service or a dynamic webpage generation service. As described herein, the residence tracking server(s) may store a residence dossier for each of the plurality of physical residences (e.g., physical residences 110-114). The plurality of physical residences may be geographically distributed in various geographic locations (e.g., Bloomington, Ill.; Denver, Colo.; Orlando, Fla., etc.). Each residence dossier may include a physical residence address (e.g., “110 Freedom Pkwy Bloomington, Ill.”) and a physical residence platform unit value (e.g., “110 platform units”).

In various embodiments, the residence tracking app, via the residence tracking server(s) 102, may receive a user selection from the residence provisioning app corresponding to a particular physical residence (e.g., physical residence 110). The user selection may include a unique identifier of the particular physical residence and an additional unique identifier of the user. The residence tracking app may also update a particular residence dossier of the particular physical residence to assign to the particular physical residence to the user. Assignment of the particular physical residence to the user grants the user the ability to reside in, or otherwise occupy, the physical residence.

In some embodiments, updating a residence dossier may include updating a blockchain transaction associated with the residence dossier. For example, in such embodiments, each residence dossier may include one or more blockchain transactions. Each blockchain transaction may indicate a transferring entity that transferred a particular physical residence and a receiving entity that was assigned the particular physical residence. For example, the transferring entity may be a stakeholder of the residential provisioning platform and the receiving entity may be a user, where the user is provisioned a physical residence from the stakeholder. In such embodiments, the platform unit values may be cryptocurrency values (e.g., bitcoin values), or other digital currency.

The residence tracking app also may update a residence profile of the user to indicate a remaining platform unit value of the particular physical residence. The residence profile may be stored on the residence tracking server(s) 102, and may include a unique identifier of the user so that the residence tracking server(s) 102 may look up, update, or otherwise manipulate the residence profile to track the user's history, status, or other information relating to the residence tracking platform.

The remaining platform unit value may be attributable to the user, and may be saved or otherwise associated with the user's residence profile in the one or memories of the residence tracking server(s) 102. The remaining platform unit value may be the platform unit value that the user must acquire to eventually own, or at least be permanently assigned to, the particular physical residence (e.g., physical residence 110). In some embodiments, the tracking app receives may receive an indicator of an existing residence dossier of an existing physical residence of the user from the residence provisioning app.

The existing residence dossier may indicate an existing platform unit value balance of the user associated with the existing physical residence. In such embodiments, the tracking app may apply the existing platform unit value balance of the existing physical residence to the remaining platform unit value of the particular physical residence. In this way, the user may transfer his existing balance from one residence to another, for example, if the user was moving from physical residence 110 to physical residence 112. If the user has additional platform unit value in his or her profile, then in some embodiments, the user may send a request from the residence provisioning app to transfer at least some of his or her existing platform unit value balance to another user (e.g., a friend or family member) of the residential provisioning platform.

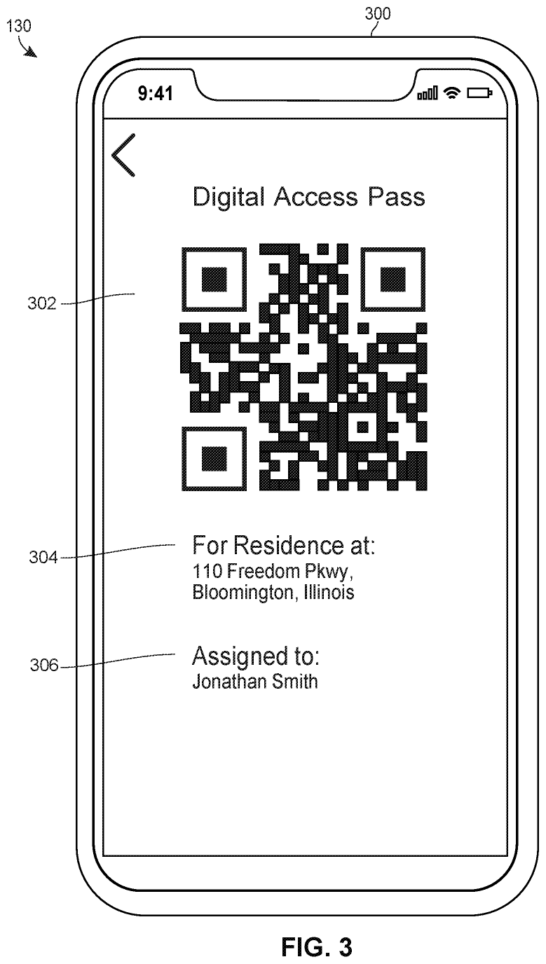

In some embodiments, the residence tracking app may transmit a digital access pass to the provisioning app, as described for FIG. 3. The digital access pass may allow access to the particular physical residence (e.g., physical residence 110).

In additional embodiments, the residence tracking app may generates an electronic moving schedule associated with moving one or more personal items of the user from an existing physical residence of the user to a newly selected physical residence. In such embodiments, the residence tracking app may transmit the moving schedule to a scheduling device, e.g., such as a scheduling device (e.g., server(s) 140) of a third-party moving service. For example, the residence tracking app may access the scheduling device to retrieve one or more available moving dates of from the third-party moving service.

In addition, the residence tracking app may access the residence provisioning app to retrieve one or more available moving dates of the user. The residence tracking app may then schedule a scheduled moving date indicated by both the moving service and the user being available. In this way, the residential provisioning platform may provide a streamlined approach to both transferring and moving between physical residences.

In still further embodiments, the tracking app may send an electronic maintenance schedule to the residence provisioning app. The electronic maintenance schedule may indicate certain date(s) when a particular physical residence of a user will receive maintenance. In this way, the physical residences (e.g., physical residences 110-114) that are operated by the stakeholder may be maintained, e.g., in good repair, so as to provide an increased value and benefit to the users of the residence provisioning platform.

### Exemplary Selection Menu

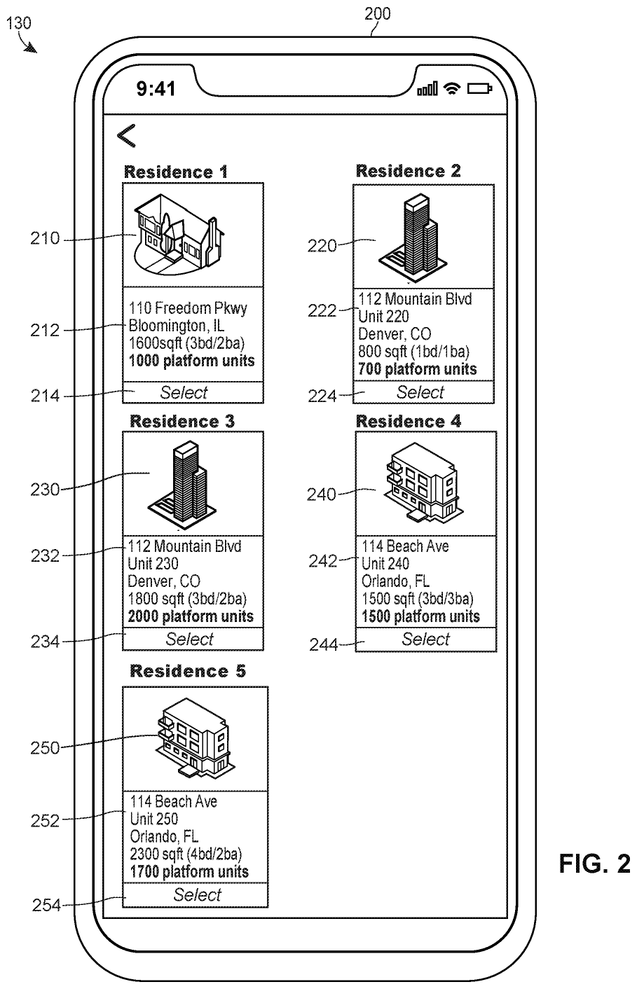

FIG. 2 illustrates an exemplary embodiment of a selection menu 200 of a residence provisioning app implemented on a user device 130 and displaying selections 210, 220, 230, 240, and 250 that correspond to a plurality of physical residences (e.g., physical residences 110-114) in accordance with certain embodiments disclosed herein. For example, as shown in FIG. 2, Residence 1 may represent a first physical residence selection 210 of the plurality of references and may correspond to physical residence 110 of FIG. 1. Selection 210 may include details 212 of the physical residence, including, for example, the address of the physical residence (e.g., “110 Freedom Pkwy, Bloomington, Ill.”), certain features of the physical residence, including square footage size (e.g., 1600 sqft), the number of beds and baths of the physical residence (e.g., 3bd/2ba), and/or the platform unit value assigned to the physical residence (e.g., 1000 platform units assigned to physical residence 110).

Similarly, Residences 2 and 3 may represent second and third physical residence selections 220 and 230, respectively, of the plurality of references and may correspond to physical residence 112 of FIG. 1. Residence selections 220 and 230 may include details 222 and 232 of the physical residences, including, for example, the address of the physical residences, certain features of the physical residences, and the platform unit values assigned to each the physical residences. As shown for FIG. 2, Residences 2 and 3 are different units (units 220 and 230) of the same apartment complex located in Denver, Colo. Each of the Residences 2 and 3 were assigned different platform units (e.g., 700 versus 2000 platform units) by the residence provisioning platform based at least on the difference in sizes (e.g., 800 sqft versus 1800 sqft) and features (e.g., 1bd/1ba versus 3bd/2ba) of each respective unit.

In addition, Residences 4 and 5 may represent fourth and fifth physical residence selections 240 and 250, respectively, of the plurality of references and may correspond to physical residence 114 of FIG. 1. Residence selections 240 and 250 may include details 242 and 252 of the physical residences, including, for example, the address of the physical residences, certain features of the physical residences, and/or the platform unit values assigned to each the physical residences. As shown for FIG. 2, Residences 4 and 5 are different units (units 240 and 250) of the same condominium complex located in Orlando, Fla. Each of the residences 4 and 5 were assigned different platform units (e.g., 1500 versus 1700 platform units, respectively) by the residence provisioning platform based at least on the difference in sizes (e.g., 1500 sqft versus 2300 sqft) and features (e.g., 3bd/3ba versus 4bd/2ba) of each respective unit. Each of the Residences 1-5 (of selections 210, 220, 230, 240, and 250) may represent some (i.e., only a subset of) of all of the physical residences available to users of the residential provisioning platform 100.

As described in various embodiments herein, a residence tracking app, via the residence tracking server(s) 102 of FIG. 1, may receive a user selection from the residence provisioning app corresponding to a particular physical residence (e.g., physical residence 110). The user selection may be corresponding to any of the selections 210, 220, 230, 240, and 250 of the selection menu 200. Each of the selections 210, 220, 230, 240, and 250 may include a selectable area of the interface (214, 224, 234, 244, and 254, respectively), as shown, in FIG. 2.

Each of the selections 210, 220, 230, 240, and 250 may also be encoded with a unique identifier of the particular physical residence. For example, Residence 1, which may correspond to physical residence 110, may have a unique identifier of “R110” that uniquely identifies the Residence 1 to the residence provisioning platform when the residence tracking server(s) 102 receives the user selection of selection 210. Each of the selections 210, 220, 230, 240, and 250 may also be encoded with a unique identifier of the user (e.g., “JS1”) which may identify the user to the residence provisioning platform when the residence tracking server(s) 102 receives the user selection of selection 210. Once the user selection is received from the residence provisioning app, the residence tracking app at the residence tracking server(s) 102 may update a particular residence dossier of the particular physical residence (e.g., physical residence 110 for selection 210) to assign to the particular physical residence to the user. As described elsewhere herein, assignment of the particular physical residence (e.g., physical residence 110) may grant the user the ability to reside in, or otherwise occupy, the physical residence.

### Exemplary Residence Access Menu

FIG. 3 illustrates an exemplary embodiment of a physical residence access menu 300 of the residence provisioning app of FIG. 2 that depicts a digital access pass 302, in accordance with certain embodiments disclosed herein. The physical residence access menu 300 may be accessed from the residence provisioning app by the user. The physical residence access menu 300 may include information about the physical residence associated with the digital access pass 302.

In the exemplary embodiment shown in FIG. 2, the residence detail 304 specifies that that the digital access pass 302 is for the physical residence with address 110 Freedom Pkwy in Bloomington, Ill., which may correspond to physical residence 110 of FIG. 1. The physical residence access menu 300 may also include user detail 306 which shows which user (“Jonathan Smith”) the physical residence (e.g., physical residence 110) is assigned to, therefore, associating the user with the physical residence of the residence provisioning platform 100 as described herein.

The digital access pass 302 that may be used to gain entry to the physical residence 110. For example, in the exemplary embodiment of FIG. 3, the digital access pass 302 may be depicted as a QR code. In the present embodiments, the particular physical residence (e.g., physical residence 110) may include an entryway communicatively coupled to a QR reader. For example, a QR reader may be configured to unlock or open a door of, or otherwise provide access to, a physical residence 110. The QR reader may scan or read the QR code to open or allow access to the particular physical residence (e.g., physical residence 110) via the entryway.

While the exemplary embodiment of FIG. 3 exemplifies a QR code 302 as a digital access pass, other embodiments are contemplated herein. For example, in another exemplary embodiment, a UPC may be used. In other embodiments, an alphanumeric passcode may be displayed, where the user enters the passcode into a keypad to gain entry. In some embodiments, the QR code, UPC, passcode, other similar code may be updated frequently so as to prevent the digital access pass from becoming “stale,” thereby increasing the security values of the digital access pass. In still further embodiments, for multi-unit physical residences with a security guard or front desk (e.g., physical residences 112 or 114), the digital passcode may be a photograph of the user, or some other identifier of the user that allows the security guard or front desk to allow access to the physical residence.

### Exemplary Residence Transfer Menu

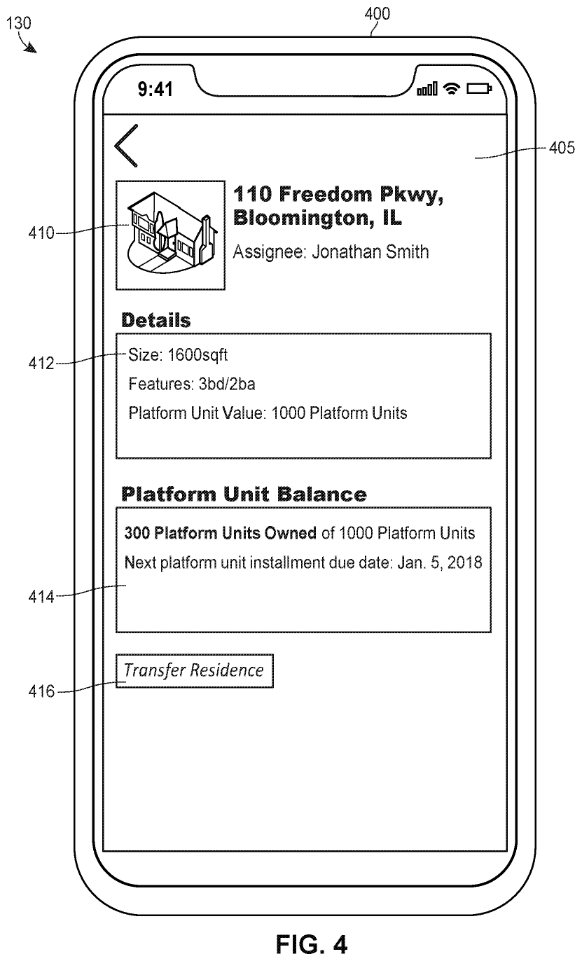

FIG. 4 illustrates an exemplary embodiment of a residence transfer menu 400 of the residence provisioning app of FIG. 2 that depicts a visualization of a residence profile 405 of a user in accordance with certain embodiments disclosed herein. The residence transfer menu 400 of the residence provisioning app may be a mobile app rendered on a user device 130 as shown in FIG. 4. The residential tracking server(s) 102 may also allow for provisioning a physical residence from a user of a residential provisioning platform 100. For example, in the exemplary embodiment of FIG. 4, the user (e.g., Jonathan Smith) may transfer his physical residence (e.g., physical residence 110) back to the residence provisioning platform 100 (e.g., to the stakeholder), or to another user of the residence provisioning platform 100.

In such embodiments, the residence provisioning app may be provided to the user for implementation on the user's device (e.g., user device 130). The residence provisioning app may cause the user device to display at least a portion of a residence dossier of a particular physical residence (e.g., physical residence 110) assigned to the user. For example, residence profile 405 may include residence dossier information displayed for the current physical residence assigned to Jonathan Smith, including the physical residence address (e.g., “110 Freedom Pkwy, Bloomington, Ill.”) and an image 410 of the physical residence 110 address.

The residence profile 405 may also include details 412 of the residence, including, in the present example, the size of the physical residence (e.g., 1600 sqft), certain features of the physical residence (e.g., 3 bedrooms and 2 bathrooms), and/or a platform unit value that was assigned to the physical residence (e.g., 1000 platform units). The residence profile 405 may also include a platform unit balance 414 of the user. The platform unit balance 414 shows that the user (Jonathan Smith) owns 300 platform units. Platform unit balance 414 also shows that those 300 platform units are applied to the 1000 platform units that represents the platform unit value assigned to the physical residence 110. Because the user owns fewer than the required platform units assigned to physical residence 110, then the user is required to obtain installments of platform units at certain periodic dates (e.g., Jan. 5, 2018 for the next installment).

Residence transfer menu 400 may also include a transfer option 416. The residence tracking app, at residence tracking server(s) 102, may receive a transfer command from the residence provisioning app when the user selects the transfer option 416. The transfer command may transfer the particular physical residence to back to the residential provisioning platform 100 (e.g., either to the stakeholder of the residence provisioning platform or to another user). The residence tracking app may then update the particular residence dossier of the particular physical residence (e.g., physical residence 110) to assign the particular physical residence back to the stakeholder or other user of the residential provisioning platform 100.

The residence tracking app may then update a residence profile of the user (e.g., Jonathan Smith) to attribute an existing platform unit value balance of the particular physical residence to the user. For example, the transfer of the particular physical residence (e.g., physical residence 110) to the user may credit the user's residence profile with a platform unit value (e.g., 300 platform units) that the user accrued overtime (and/or paid-in initially) for the particular residence (e.g., physical residence 110).

In some embodiments, transfer of the particular physical residence may cause the user to lose access to the particular physical residence (e.g., for the physical residence 110), for example, where the residence tracking app transmits a reassignment signal to the provisioning app. The reassignment signal may revoke a digital access pass (e.g., may revoke the QR code as described for FIG. 3) of the particular physical residence that the user had previously received. In this way, the residential provisioning platform 100 may seamlessly handle returning the particular physical residence (e.g., for the physical residence 110) back to the inventory of the stakeholder or user. In some embodiments, the reassignment signal to revoke a digital access pass may be sent after a specified move-out time period (e.g., a week) to allow the user time to move, or schedule to move, his or her items out of the physical residence as described herein.

### Exemplary Computer-Implemented Method

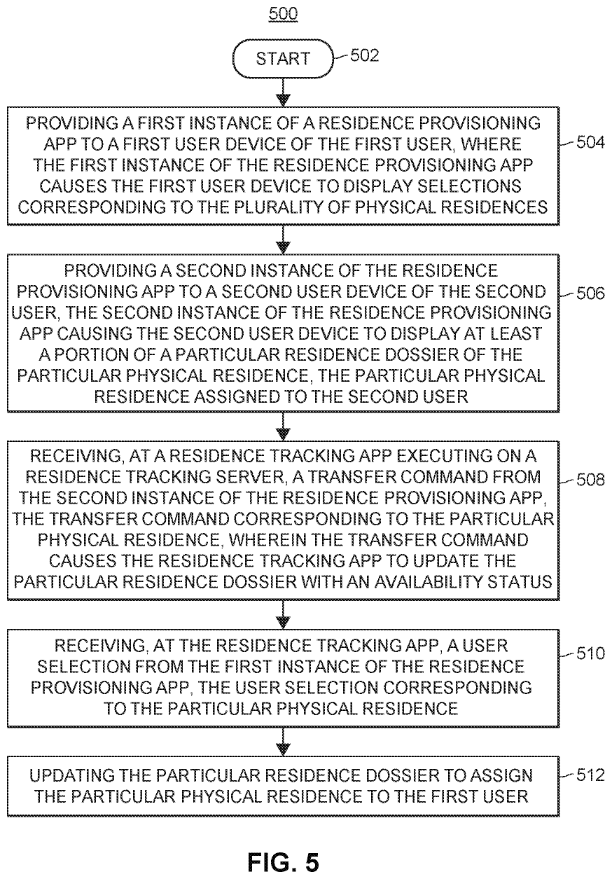

FIG. 5 illustrates an exemplary computer-implemented method 500 for provisioning a particular physical residence (e.g., physical residence 110) from a second user of a residential provisioning platform to a first user of the residential provisioning platform. As described for various exemplary embodiments herein, the residential provisioning platform 100 may assign platform unit values to each of a plurality of physical residences (e.g., physical residences 110-114).

Method 500 may begin (502) at block 504 where a first instance of a residence provisioning app is provided to a first user device (e.g., a user device 130) of the first user. The first instance of the residence provisioning app may be a mobile app (e.g., an Apple App) downloaded from a mobile app store (e.g., the Apple App store). The residence provisioning app may cause the first user device (e.g., a user device 130) to display selections corresponding to the plurality of physical residences. The selections may be selections 210, 220, 230, 240, and 250 of selection menu 200 as described herein for FIG. 2.

At block 506, a second instance of the residence provisioning app may be provided to a second user device (e.g., a user device 130) of a second user. The second instance of the residence provisioning app may be a mobile app (e.g., a Google app) downloaded from a mobile app store (e.g., the Google Play store). The second instance of the residence provisioning app may cause the second user device (e.g., user device 130) to display at least a portion of a particular residence dossier of the particular physical residence. For example, the portion of a particular residence dossier of the particular physical residence may be the portion of the residence dossier displayed in FIG. 4 (e.g., via the residence transfer menu 400) for the particular physical residence (e.g., physical residence 110 with address “110 Freedom Pkwy, Bloomington, Ill.”) assigned to Jonathan Smith.

At block 508, the residence tracking app executing on the residence tracking server(s) 102 may receive a transfer command from the second instance of the residence provisioning app. For example, the transfer command may be initiated and sent from the residence transfer menu 400 as described for FIG. 4. The transfer command may be for the particular physical residence (e.g., physical residence 110). Upon receiving the transfer command, the residence tracking may update the particular residence dossier (e.g., of physical residence 110) with an availability status. The availability status may indicate to users of the residence provisioning platform 100 that the physical residence 110 is available for assignment to other users.

At block 510, the residence tracking app may receive a user selection from the first instance of the residence provisioning app, where the user selection corresponds to the particular physical residence (e.g., physical residence 110). The user selection may be initiated from the selection menu 200 of FIG. 2 as described herein.

At block 512, the residence tracking app may update particular residence dossier to assign the particular physical residence to the first user. In this way, the second user may seamlessly transfer a physical residence to the first user without having to use any of a realtor, banker, or other traditional real estate transaction personnel in order to secure a residence in a given geographic region, all as performed by the residential provisioning platform 100 as described herein.

### Machine Learning

As described herein, a machine learning model may be trained using a supervised or unsupervised machine learning program. The machine learning program may employ a neural network, which may be a convolutional neural network, a deep learning neural network, a reinforced learning program, or a combined learning module or program that learns in two or more features or feature datasets in a particular areas of interest. The machine learning programs may also include natural language processing, semantic analysis, automatic reasoning, regression analysis, clustering, reinforcement learning, and/or other machine learning algorithms. Machine learning may involve identifying and recognizing patterns in existing data (such as prices or platform values of physical residence in various geographic locations) in order to facilitate making predictions for subsequent data (again, such prices or platform values of physical residence in various geographic locations). Models may be created based upon example inputs (i.e., features and labels) of data in order to make valid and reliable predictions for novel inputs.

In supervised machine learning, a processing element may be provided with example inputs (e.g., “features”) and their associated outputs (e.g., “labels”), and may seek to discover a general rule that maps inputs to outputs, so that when subsequent novel inputs are provided the processing element may, based upon the discovered rule, accurately predict the correct or a preferred output. In unsupervised machine learning, the processing element may be required to find its own structure in unlabeled example inputs.

### Blockchain & Blockchain Transactions

As used herein, a blockchain may refer to a digitized ledger of network-based transactions. The blockchain may comprise a set of “completed” blocks of transactions that are recorded and added in a chronological order. A “block” may refer to a current or existing portion of a blockchain that includes a set of transactions accumulated during a certain period of time (e.g., 10 minutes). Once completed, a block may be added to the blockchain as a permanent record. The first block in a blockchain may be referred to as the “genesis block.” A second block may later be added (or “chained”) to the genesis block, and a third block may be added (or chained) to the second block and so on. In this way, new blocks may be added to old blocks, creating an ever growing set of blocks of transaction records, i.e., a blockchain.

In addition, each block may contain a computerized hash value of the previous block. The hash value may allow users of the blockchain to verify the integrity and authenticity of the blockchain as a whole, where hash values across all blocks of the chain, down to the genesis block, may be verified. The blockchain may also maintain information about different users of the blockchain, including, for example, addresses, contact information, balances, etc.

The blockchain may be accessible via a network, which may be public or private, and allows its users to track the digital transactions of the various blocks over time. Each of the blockchain block and their related transactions may be stored on “nodes” of a network. The nodes may be computers or other storage devices connected to the network. Each node may replicate the blockchain (and respective blocks and transactions) such that each node has its own copy.

In this way, no one node maintains, or may manipulate, its own blockchain without that blockchain differing from the other blockchain records of the other nodes in the network. For example, each node may verify the transactions by assessing the blockchain transactions and records at all of the other nodes. In other words, because each node keeps a copy of the blockchain transactions (and therefore copies of the digital documents), the record's authenticity may be verified by the entire community accessing the blockchain nodes as a whole.

Blockchains may also add transaction information (e.g., digital documents) by digitizing, encoding, and inserting such transaction information into the blockchain. Such digital documents may be stored in the blockchain, and may be indelible records that cannot be changed as described above. Specifically, the transactions of the blockchain may be immutable (e.g., they cannot be deleted or altered). Moreover, the blocks may be added to the blockchain via cryptography, which allows the transactions to resist tampering from outside attacks.

### Exemplary Residence Share Embodiments

The present embodiments may disrupt mortgage, homeownership, and renter industries. An enterprise or company, such as a stakeholder entity, may do this by creating a residence platform (e.g., the residential provisioning platform 100 described herein) where the stakeholder entity owns houses, apartments, duplexes, condos, and other types of dwellings throughout the nation or a geographical area, and customers/users own residence shares to move freely between any available home or other residence they choose, whenever they choose. The terms residence shares, shares, and platform units are used interchangeably herein.

Residence shares may be bought and sold, similar to shares of stocks listed on a stock market or stock exchange. The residence shares may also increase or decrease in value. For example, the residence shares may be tied to the overall or national housing market, a local housing market, the economy, unemployment rate, stock market indexes, an individual state, or neighborhood, or one or more other factors that may cause the shares to increase or decrease in value relative to such factors.

In some embodiments, residence shares may act as a security deposit. For example, a user with no current shares may purchase enough share quantity such that the share quantity essentially acts as, or has the value of, a conventional down payment for a property. After which, the user could move into the property, and be required to purchase a number of additional residence shares periodically, such as monthly. The user may then desire to move to another residence at some point in the future. The current value of his or her existing residence shares may be calculated, and/or those current residence shares may be used as a quasi-down payment on a new property, and allow the user to easily transfer a portion of residual “ownership” in the existing residence to the new residence—the portion of ownership represented by the residence shares as transferred from the existing to the new residence.

In other words, the residence shares may act much like home equity and be an investment electronically bought, sold, and transferred like stocks and/or over a network. A company, such as stakeholder entity as described herein, may manage the investment, and take a percentage of investment earnings as a fee. To create one-click, painless moving, the stakeholder may also be affiliated with a national moving service, or similar third party, as described herein, and be provided as a value added option to users of the residential provisioning platform. This may also enable the company to complete a home inventory for the user during the moving process. The company may also be affiliated with a home maintenance company to maintain the owned houses or other residences, and prevent major repairs/damage, which may maintain/increase the value of the residence when later sold when appropriate. The stakeholder may also provide homeowners or renters insurance covering the residences.

Providing the means for readily exchanging residence shares may allow users of all ages to easily and painlessly move to a home (e.g., residence) and location they choose, whenever they choose. They may no longer be anchored to a standard mortgage, house, location, and paying decades of interest, taxes, and cost of ownership.

As described above, with the residence provisioning platform (e.g., residence provisioning platform 100) for transferring residence shares, a stakeholder may own dwellings (homes, condos, apartments, duplexes, etc.) nationally, locally, or regionally. Users may own residence shares, and may be able to move freely to or between homes, or other residences, that are valued to their designated number of shares or below at any time they wish to any location which is available. Moving to a more expensive residence would, however, require a customer to purchase additional residence shares to make up the difference in some embodiments.

As an example, a 3 bedroom, 2 bathroom home in Bloomington, Ill. may be valued at 1,000 residence shares. A user of the residential provisioning platform, such as a younger person right out of school, may start out by purchasing a minimum amount of shares, and over the course of time (e.g., 15-30 years), be obligated to purchase a minimum amount of shares monthly until they own 1,000 shares.

As another example, a 3 bedroom, 2 bathroom home in Bloomington, Ill. may be valued at 1,000 residence shares. A user who owns 700 shares may decide they would like to move to 3 bedroom, 2 bathroom house in Denver, Colo., which is valued at 2,000 shares. In such an embodiment, the user would need to purchase, or otherwise obtain, 1,300 additional shares in order to “own” or otherwise move into the residence.

As another example, a user may desire to transfer from a 3,000 share home to a 1,000 share home. If the existing home were owned by the user outright, there would be no more shares to purchase, and a 2,000 share excess may be kept as an investment, liquidated, or transferred (e.g., “gifted”) in whole or part to another user (e.g., such as a relative). If the user is below 1,000 shares, the user may be required to continue to purchase a minimum amount of shares (e.g., on timely basis, e.g., monthly) until the user owned the required number of shares equaling the value of the home residence.

In some embodiments as disclosed herein (for example, with respect to certain embodiments of the infinity home platform (IHP) disclosed further herein), each home value is determined as a projected home value based upon the current value of the home (e.g., a current market value of the home) plus a projected tax value over certain time period(s) (e.g., 30 years, 360 periods, etc.). In such embodiments, and as described further herein, the projected home value is, or forms the basis for, the number of shares for a user to purchase (e.g., each month or some other time period) to eventually own the home. Meeting the projected home value may be, for example, includes in the terms of a contract for ownership of the home.

In various embodiments described herein, residential shares (e.g., platform units) may be similar to home equity, while also being an investment. For example, the residential shares may be able to be electronically bought, sold, and transferred like stocks. However, unlike a timeshare, which may provide limited occupancy for designated times of the year, ownership, or assignment of the residences, as described herein, may be based upon full time or permanent residency.

Additionally, the present embodiments (e.g., the residential provisioning platform 100) may provide the ability to use or trade residence shares in order to outright purchase a home from the home residence provisioning platform; the ability to trade or sell a home in order to receive a residence shares (e.g., platform units); and/or creation of algorithms to predict when home markets in specific areas throughout the nation are warming or cooling (e.g., with respect to the prices of the homes increasing or decreasing in specific geographic locations and at certain times during the year, economic business cycle, or otherwise). This last feature may enable an owning company, e.g., a stakeholder entity of the residential provisioning platform 100, to purchase dwellings before price increases, and sell homes at the start of cooling trends (e.g., price decreases in specific geographic locations).

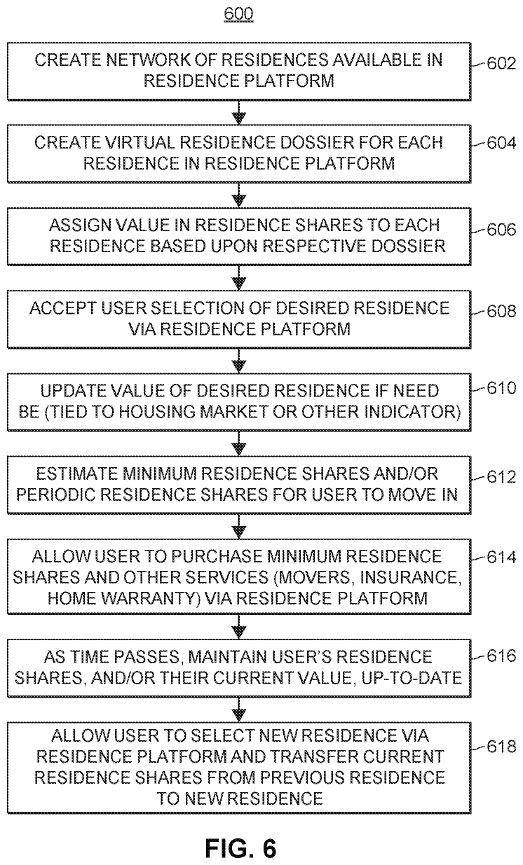

FIG. 6 depicts an exemplary computer-implemented method 600 of using residence shares (e.g., platform units) to allow users to move efficiently from one residence to another, and still maintain some equity or ownership interest by having the equity or ownership interest transfer from one residence to another via a residence share mechanism (e.g., the tracking app, tracking server(s) 102, or, more generally, the residential provisioning platform 100 described herein).

For example, in various embodiments, the residential provisioning platform 100 may track the residences available to users of the residential provisioning platform 100, and may also track the platform units owned by individual users. The residences of the residential provisioning platform may include geographically distributed and/or diverse properties including, for example, any of physical residences 110-114, as described herein. The users of the residential provisioning platform 100 may access (e.g., via the residence provisioning app) the residence provisioning platform 100 to use platform units to move from one residence to another.

The method 600 may include, at block 602, creating, tracking and/or storing a virtual network of residences that are available for occupancy (e.g., in some cases, for immediate occupancy) and that may be available for display via a residence platform (e.g., residential provisioning platform 100 as described herein). For instance, an entity may own numerous houses in a state or city. In addition, as described herein, the houses, or otherwise physical residences, may be geographically distributed in multiple states or other locations. The physical residences of the virtual network may be any of physical residences 110-114, as described herein. The network of physical residences may be stored in the one or more memories of the tracking server(s) 102. Each physical residence in the virtual network of physical residences may be associated with an indicator (e.g., a Boolean value) that indicates whether a particular physical residence is available for occupancy or is otherwise unavailable (e.g., is currently occupied).

In some embodiments, the network of physical residences may be stored, tracked, and/or accessed in the tracking server(s) 102 via a database. The database may be any of a relational database, a NoSQL database, or other database type that allows the network of physical residences to be tracked or maintained. For example, the database may track or maintain the network of physical residences in addition to tracking and maintaining owners, users, share values (e.g., remaining share balances, etc.) associated with each physical property of the network of physical residences. The database may be stored in the one or more memories of the residence tracking server(s) 102, or elsewhere in the residential provisioning platform 100.

At block 604, a virtual dossier (e.g., a residence dossier as described herein) may be created for each residence (e.g., physical residences 110-114), and uploaded to and/or stored with the residence platform (e.g., the residential provisioning platform 100) for potential residents (e.g., users of the residential provisioning platform 100) to view. For example, as described for several embodiments herein, a residence dossier may be stored in the one or more memories of the residence tracking server(s) 102 of residential provisioning platform 100.

In some embodiments, a residence or virtual dossier may be stored as one or more tables, or otherwise one or more data structures, in a database, such as in a relational database or NoSQL database stored on residence tracking server(s) 102. In some embodiments, a residence dossier may be retrieved via SQL statements or instructions issued to the database. In other embodiments, a residence dossier may be retrieved via text-based commands or formats, such as the JavaScript Objection Notation (JSON) format.

At block 606, a value in residence shares (e.g., platform units) may be assigned to each residence in the network or on the platform (e.g., residential provisioning platform 100 as described herein). The residence value (e.g., platform unit value) may be stored in the residence tracking server(s) 102, with the other information associated with each particular residence.

For example, in some embodiments, the residence value may be stored in each residence dossier, which can be included within a same database table or data structure that stores a particular residence dossier associated with a particular residence. In other embodiments, the residence value may be stored separately, for example in the profile of a user or in a separate database table or other data structure. In some embodiments, the residence value may be determined by residence characteristics as stored in the respective dossier.

The residence characteristics may be of particular physical residences (e.g., physical residences 112-114) as describe herein, for example, as described for any of FIGS. 1 and/or 2. For example, each of the selections 210, 220, 230, 240, and 250 that correspond to a plurality of physical residences (e.g., physical residences 110-114), include residence characteristics including location (e.g., address), square footage, number of bedrooms, number of bathrooms, unit number, number of floors, if there is a pool or basement, size of garage, HOA fees (if any), age, age of roof or air conditioning unit, type of appliances, school district, size of yard, etc.

At block 608, a user may visit the residence platform (e.g., residential provisioning platform 100) online, view available residences, and select a preferred residence (e.g., physical residence 112). For example, as described herein, a user may use the residence provisioning app to view and select physical residences (e.g., any of physical residences 110-114 and corresponding selections 210, 220, 230, 240, and 250). The residence provisioning app may be in communication with the residence tracking server(s) 102 (e.g., and the residence tracking app) via computer network 120, where the residence provisioning app initiates requests to the residence tracking server(s) 102/residence tracking app to view and/or send selection information regarding physical residences (e.g., any of physical residences 110-114 and corresponding selections 210, 220, 230, 240, and 250).

For example, in a first request, the residence provisioning app may request information regarding the physical residences (e.g., physical residences 110-114) from the residence tracking server(s) 102/residence tracking app, where the residence tracking server(s) 102/residence tracking app returns such physical residence information that is displayed on a user device, e.g., as shown in FIG. 2. The user may then select a preferred physical residence (e.g., physical residence 112) from the screen of the user device. The selection of the preferred residence may then be transmitted back (e.g., via computer network 120) to the residence tracking server(s) 102/residence tracking app, where the preferred residence may become associated with, or otherwise attributed to, the user as described herein. The requests and responses to and from the residence provisioning app may, in some embodiments, be HTTP requests, where for example, the residence provisioning app communicates over computer network 120 via a RESTful API exposed on tracking server(s) 102 and/or by the residence tracking app.

At block 610, the current residence value (e.g., platform unit value) of the selected residence in residence share may be updated if need be. In some embodiments, for example, the residence tracking server(s) 102 may aggregate regional, geographic, or other related information associated with the current residence (e.g., the preferred or selected residence), and, based upon such information, may update the residence value by either increasing or decreasing the platform unit value of the residence. For example, the platform unit value of available residences may be tied to current economic conditions (as determined from current economic condition data), such as the stock or housing market. Such economic conditions may be geographic specific (e.g., affecting the area where the residence is situated only), or may be regional or national (e.g., affecting areas outside the general area of the residence). As described herein, machine learning models (e.g., such as machine learning models based upon neural networks) may be used to determine economic conditions.

In some embodiments, the value of the residence may be determined by analyzing values of sales of nearby comparable residences, where the values of the comparable residences are the labels of the machine learning model and the residence characteristics make up the features. A machine learning model may be trained on such labels and features to thereby make predictions of the economic conditions for a given residence. Using such predictions, the platform unit value of the residence may be determined, and my be updated accordingly, e.g., by adjusting the platform unit value either up or down based upon the prediction of the machine learning model.

At block 612, the method 600 may estimate the minimum residence shares (e.g., platform units), and/or any periodic residence shares, required for the user to be allowed to move into the residence (e.g., physical residence 112) that they have selected. For example, the residence tracking server(s) 102/residence tracking app may implement block 612, where the residence tracking server(s) 102/residence tracking app receive the selection via computer network 120 from the user for physical residence 112. The selection may be received from the residence provisioning app as described herein, where, for example, the selection request includes a unique identifier that identifies the user (and, by extension, the user's residence profile) on the residence tracking server(s) 102. The residence tracking server(s) 102/residence tracking app may access the residence profile of the user to determine how many platform units the user currently has.

In some embodiments, the user's platform units may be associated with an existing physical residence (e.g., a residence at which the user currently resides). In other embodiments, the user's platform units may be platform units that the user has saved or purchased as an investment. In still further embodiments, the residence tracking server(s) 102/residence tracking app may determine, from the residence profile of the user, that the user needs additional, or a minimum number of, platform units in order to own, or otherwise be assigned, the physical residence (e.g., physical residence 112). In such embodiments, the tracking server(s) 102/residence tracking app may associate, or attribute, the additional or remaining required platform units to the user by updating the residence profile of the user to indicate the additional or remaining required platform units.

In such embodiments, the tracking server(s) 102/residence tracking may generate a routine or periodic electronic payment schedule (e.g., monthly), where the user is required to purchase additional/minimum platform units according to the schedule, and until the user has obtained sufficient platform units equal to the value of the physical residence as determined by the residential provisioning platform 100 (e.g., the tracking server(s) 102/residence tracking app). In some embodiments, the electronic schedule may be sent from the tracking servers(s) 102/residence tracking app to the residence provisioning app for display to the user on the user's user device 130, or other mobile device.

At block 614, the residence platform (e.g., residence provisioning platform 100, for example, via the tracking server(s) 102/residence tracking app) may allow the user to electronically purchase the minimum amount of residence shares (e.g., platform units) needed to move in, as well as other services, such as movers, home or personal articles, insurance, and/or home warranties via the platform. For example, the user, via the residence provisioning app installed on the user's device, may request to purchase additional platform units in a scenario where the user does not have enough platform units to own, or otherwise obtain occupancy of, a particular residence.

For example, the user may be attempting to acquire physical residence 112 as shown in selection 230, but the user may only have 1000 platform units. Because the platform unit value of physical residence 112 as shown in selection 230 is valued at 2000 platform units, when the user selects (234) the selection 230 from the selection menu 200, then the tracking server(s) 102/residence tracking app may send a notification to the user that includes information the user needs an additional 1000 platform units. Such notification may be displayed on the user device 130. The notification may present several selection options to the user, the selection options presenting one or more ways for the user to obtain the additional/remaining platform units required for the user to own or otherwise obtain access to the physical residence.

In some embodiments, the user may select to purchase the 1000 platform units, which would cause a request (e.g., via computer network 120) to be sent from the user device 130 to the tracking server(s) 102/residence tracking app to execute a transaction where the user paid for the 1000 platform units outright (e.g., via a bank account, or other asset or account). In other embodiments, the notification may present a schedule to the user for payment of the additional/remaining platform units needed over time.

Upon selection of the scheduling option, the tracking server(s) 102/residence tracking app may set up scheduled payments where the user pays for platform units in accordance with the schedule. In some embodiments, an asset account of the user (e.g., a bank account) may be linked to the residential profile of the user where the scheduled payments are deducted from the user's asset account and used to purchase the platform units according to the schedule.

As time passes, the method 600, at block 616, may include maintaining the user's total number of residence shares (e.g., platform units at residence provisioning platform 100), and/or their current value (if it fluctuates), up-to-date. The platform units of each user may be maintained in the residence profile of the user. For example, in embodiments where the user chooses to schedule platform units over time, the tracking server(s) 102/residence tracking app may maintain the user's total platform units in the residence profile of the user, where the user's total platform unit amount may be updated to reflect the additional platform units purchased over time by the user.

In other embodiments, the users may move to, sell, buy, or otherwise transition to and from the physical residences (e.g., physical residences 110-114) such that the amount of platform units fluctuates, and is maintained in the residence profile of each user, for any given number of related transactions. For example, a user may sell or otherwise relinquish a physical residence in which the user currently resides, causing the tracking server(s) 102/residence tracking app to credit the user's residence profile with the platform units in the amount of the current value of the physical residence as determined by the residence provisioning platform 100 as described herein.

In another embodiment, a user may buy or otherwise request possession of a physical residence in which the user desires to move into, causing the tracking server(s) 102/residence tracking app to debit the user's residence profile with the platform units in the amount of the current value of the physical residence as determined by the residence provisioning platform 100 as described herein. If more platform units are required, then then the tracking server(s) 102/residence tracking app may notify the user of the additional units required/remaining, and may maintain the residence profile of the user by attributing such remaining platform units to the user, such as by updating the residence profile of the user to require future payments to purchase additional platform units for purchase of the new physical residence (e.g., physical residence 112). In some embodiments, the tracking server(s) 102/residence tracking app may maintain the transaction(s) of a user in the residence profile of the user, such as via a list of transactions in memory or in a database of the tracking server(s) 102.

The method 600 may include, at block 618, allowing the user to select a new residence (e.g., physical residence 114) via the residence platform (e.g., residence provisioning platform 100), and transfer the current residence shares from the previous residence (e.g., physical residence 110 or 112) to the new residence (e.g., physical residence 114). For example, the residence profile of the user may, in a first instance, attribute a platform unit value of a first (previous) physical residence (e.g., physical residence 110 or 112) with the user. The user may select a second (new) residence (e.g., physical residence 114), for example from selection menu 200 of FIG. 2, as described herein, where such selection may cause the tracking server(s) 102/residence tracking app to update the residence profile of the user to disassociate the previous physical residence with the user and attribute or associate the new physical residence with the user, thereby transferring ownership/occupancy of the new physical residence to the user.

Such transition may also cause the residence tracking server(s) 102/residence tracking app to credit the residence profile of the user with a platform unit value amount of the previous physical residence and apply that platform unit value amount against the platform unit value of the new physical residence, such that the user has a new outstanding balance for the new physical residence. In some instances, the user may be required to purchase additional platform units (e.g., according to a scheduled payment plan).

In other embodiments, as described herein, the user may break even (when the platform unit value of the existing residence and new residence is equal), and in other instances the residential provisioning platform may credit the user's residential profile, or other account, with platform units that are in surplus to the amount of platform units that the user needed to own or obtain occupancy of the new physical residence. The method 600 may include additional, less, or alternate actions, including those discussed elsewhere herein.

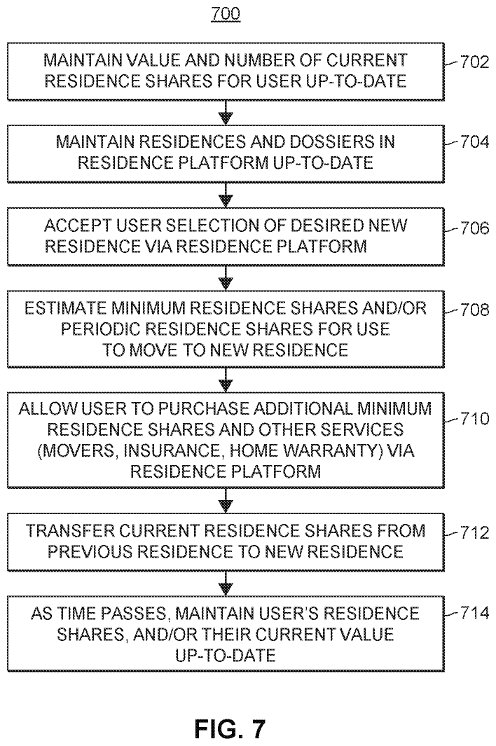

FIG. 7 depicts another exemplary computer-implemented method 700 of using residence shares (e.g., platform units) to allow residents to move efficiently from one residence to another, and still maintain some equity or ownership interest by having the equity or ownership interest transfer from one residence to another via a residence share mechanism, e.g., residence provisioning platform 100 as described herein. The method 700 may include, at block 702, maintaining the current number of residence shares (e.g., platform units) (and, current value, platform unit value, if the value fluctuates) for a user in an up-to-date manner at the residence provisioning platform 100. As described herein, the platform units of each user may be maintained by the residence tracking server(s) 102, e.g., in the residence profile of the user. The residence profile may be stored as a table in a database (e.g., relational or NoSQL database).

In other embodiments, the platform units may be stored separately and associated, or linked or otherwise associated, to users or physical residences of the provisioning platform 100 as the physical residences are bought, sold, maintained, or otherwise transitioned among the various users, stakeholder, or other parties using or associated with the residence provisioning platform 100. The platform units may be kept up-to-date where the tracking server(s) 102/residence tracking app updates the platform units (e.g., in the various user residence profiles or otherwise stored in memory or the database) by crediting, debiting, or otherwise altering the platform unit values of the users and physical residences to maintain an overall value of platform units with respect to the current users and physical residences available and participating in the residence provisioning platform at a given time.

At block 704, the method 700 may include maintaining residences and dossiers, as described herein, in the residence platform (e.g., residence provisioning platform 100) up-to-date. Each of the physical residences may be stored, tracked, maintained, and/or accessed in the tracking server(s) 102 via residence dossiers, e.g., in the one or more memories of the tracking server(s) 102. Each residence dossier in may be associated with an indicator (e.g., a Boolean value) that indicates whether a particular physical residence is available for occupancy, or is otherwise unavailable (e.g., is currently occupied). Each residence dossier may be stored, tracked, maintained, and/or accessed in the tracking server(s) 102 via a database. The database may be any of a relational database, a NoSQL database, or other database type that allows the physical residences dossiers to be tracked or maintained.

For example, the database may track or maintain the physical residences dossiers in addition to tracking and maintaining owners, users, share values (e.g., remaining share balances, etc.) associated with each physical property in the residence provisioning platform 100. The database may be stored in the one or more memories of the residence tracking server(s) 102, or elsewhere in the residential provisioning platform 100. In some embodiments, a residence dossier may be retrieved via SQL statements or instructions issued to the database. In other embodiments, a residence dossier may be retrieved via text-based commands or formats, such as the JavaScript Objection Notation (JSON) format.

In some embodiments, the residence dossiers may be kept up-to-date by the tracking server(s) 102 where the tracking server(s) 102/residence tracking app tracks a list of transactions associated with each physical residence of the residence provisioning platform. For example, the tracking server(s) 102/residence tracking app may maintain (e.g., in its one or more memories or database) a transaction record for each transaction in the database where a property is transitioned from one user to another, or to a stakeholder to a user, or a user to a stakeholder, etc. The transaction record may include a first party (user or stakeholder) that a physical residence is being transitioned from, a second party (user or stakeholder) that a physical residence is being transitioned to, a platform unit value associated with the transaction (e.g., the platform unit value of the physical residence being transferred), a description or unique identifier of the physical residence being transferred, etc.

At block 706, the method 700 may include accepting user selection of a desired new residence (e.g., physical residence 112) via the residence platform. For example, as described herein, a user may use the residence provisioning app to view and select physical residences (e.g., any of physical residences 110-114 and corresponding selections 210, 220, 230, 240, and 250). The residence provisioning app may be in communication with the residence tracking server(s) 102 (e.g., and the residence tracking app) via computer network 120, where the residence provisioning app initiates requests to the residence tracking server(s) 102/residence tracking app to view and/or send selection information regarding physical residences (e.g., any of physical residences 110-114 and corresponding selections 210, 220, 230, 240, and 250).

For example, in a first request, the residence provisioning app may request information regarding the physical residences (e.g., physical residences 110-114) from the residence tracking server(s) 102/residence tracking app, where the residence tracking server(s) 102/residence tracking app returns such physical residence information to the user device/residence provisioning app that is displayed on a user device, e.g., as shown in FIG. 2. The user may then select a preferred physical residence (e.g., physical residence 112) from the screen of the user device. The selection of the preferred residence may then be transmitted back (e.g., via computer network 120) to the residence tracking server(s) 102/residence tracking app. The requests and responses to and from the residence provisioning app may, in some embodiments, be HTTP requests, where for example, the residence provisioning app communicates over computer network 120 via a RESTful API exposed on tracking server(s) 102 and/or by the residence tracking app.

At block 708, the method 700 may include estimating a minimum amount of shares (e.g., platform units) and/or periodic shares needed for the user to move into the new residence (e.g., physical residence 112). For example, the residence tracking server(s) 102/residence tracking app may implement block 708, where the residence tracking server(s) 102/residence tracking app receive the selection via computer network 120 from the user for physical residence 112. The selection may be received from the residence provisioning app as described herein, where, for example, the selection request includes a unique identifier that identifies the user (and, by extension, the user's residence profile) on the residence tracking server(s) 102. The residence tracking server(s) 102/residence tracking app may access the residence profile of the user on the tracking server(s) 102 (and via the residence tracking app) to determine how many platform units the user currently has.

In some embodiments, the user's platform units may be associated with an existing physical residence (e.g., a residence at which the user currently resides). In other embodiments, the user's platform units may be platform units that the user has saved or purchased as an investment. In still further embodiments, the residence tracking server(s) 102/residence tracking app may determine, from the residence profile of the user, that the user needs additional, or a minimum number of, platform units in order to own, or otherwise be assigned, the physical residence (e.g., physical residence 112). In such embodiments, the tracking server(s) 102/residence tracking app may associate, or attribute, the additional or remaining required platform units to the user by updating the residence profile of the user to indicate the additional or remaining required platform units. In such embodiments, the tracking server(s) 102/residence tracking may generate a routine or periodic electronic payment schedule (e.g., monthly), where the user is required to purchase additional/minimum platform units according to the schedule, and until the user has obtained sufficient platform units equal to the value of the physical residence as determined by the residential provisioning platform 100 (e.g., the tracking server(s) 102/residence tracking app). In some embodiments, the electronic schedule may be sent from the tracking servers(s) 102/residence tracking app to the residence provisioning app for display to the user on the user's user device 130.

At block 710, the method 700 may include allowing the user to purchase additional shares (to meet the minimum amount of shares, e.g., platform units, required) and/or other services via the platform. For example, the user, via the residence provisioning app installed on the user's device, may request to purchase additional platform units in a scenario where the user does not have enough platform units to own, or otherwise obtain occupancy of, a particular residence. For example, the user may be attempting to acquire physical residence 112 as shown in selection 230, but the user may only have 1000 platform units. Because the platform unit value of physical residence 112 as shown in selection 230 is valued at 2000 platform units, when the user selects (234) the selection 230 from the selection menu 200, then the tracking server(s) 102/residence tracking app may send a notification to the user that includes information the user needs an additional 1000 platform units. Such notification may be displayed on the user device 130.

The notification may present several selection options to the user, the selection options presenting one or more ways for the user to obtain the additional/remaining platform units required for the user to own or otherwise obtain access to the physical residence. In some embodiments, the user may select to purchase the 1000 platform units, which would cause a request (e.g., via computer network 120) to be sent from the user device 130 to the tracking server(s) 102/residence tracking app to execute a transaction where the user paid for the 1000 platform units outright (e.g., via a bank account, or other asset or account).

In other embodiments, the notification may present a schedule to the user for payment of the additional/remaining platform units needed over time. Upon selection of the scheduling option, the tracking server(s) 102/residence tracking app may set up scheduled payments where the user pays for platform units in accordance with the schedule. In some embodiments, an asset account of the user (e.g., a bank account) may be linked to the residential profile of the user where the scheduled payments are deducted from the user's asset account and used to purchase the platform units according to the schedule.

At block 712, the method 700 may transfer the current residence shares from being associated with an existing residence (e.g., physical residence 110) to being associated with the new residence (e.g., physical residence 112). For example, the residence profile of the user may, in a first instance, attribute a platform unit value of a first (previous) physical residence (e.g., physical residence 110 or 112) with the user. The user may select a second (new) residence (e.g., physical residence 114), for example from selection menu 200 of FIG. 2, as described herein, where such selection may cause the tracking server(s) 102/residence tracking app to update the residence profile of the user to disassociate the previous physical residence with the user, and attribute or associate the new physical residence with the user, thereby transferring ownership/occupancy of the new physical residence to the user. Such transition may also cause the residence tracking server(s) 102/residence tracking app to credit the residence profile of the user with a platform unit value amount of the previous physical residence and apply that platform unit value amount against the platform unit value of the new physical residence, such that the user has a new outstanding balance for the new physical residence.

In some instances, the user may be required to purchase additional platform units (e.g., according to a scheduled payment plan). In other embodiments, as described herein, the user may break even (when the platform unit value of the existing residence and new residence is equal), and in other instances the residential provisioning platform may credit the user's residential profile, or other account, with platform units that are in surplus to the amount of platform units that the user needed to own or obtain occupancy of the new physical residence.

As time passes, the method 700, at block 714, may include maintaining a user's number of residence shares and/or their value up-to-date, for example, as associated with the new residence. The platform units of each user may be maintained in the residence profile of the user. For example, in embodiments where the user chooses to schedule platform units over time, the tracking server(s) 102/residence tracking app may maintain the user's total platform units in the residence profile of the user, where the user's total platform unit amount may be updated to reflect the additional platform units purchased over time by the user. In other embodiments, the users may move to, sell, buy, or otherwise transition to and from the physical residences (e.g., physical residences 110-114) such that the amount of platform units fluctuates, and is maintained in the residence profile of each user, for any given number of related transactions.

For example, a user may sell or otherwise relinquish a physical residence in which the user currently resides, causing the tracking server(s) 102/residence tracking app to credit the user's residence profile with the platform units in the amount of the current value of the physical residence as determined by the residence provisioning platform 100 as described herein. In another embodiment, a user may buy or otherwise request possession of a physical residence in which the user desires to move into, causing the tracking server(s) 102/residence tracking app to debit the user's residence profile with the platform units in the amount of the current value of the physical residence as determined by the residence provisioning platform 100 as described herein.

If more platform units, which may also be referred to as shares herein, are required, then then the tracking server(s) 102/residence tracking app may notify the user of the additional units required/remaining, and may maintain the residence profile of the user by attributing such remaining platform units to the user, such as by updating the residence profile of the user to require future payments to purchase additional platform units for purchase of the new physical residence (e.g., physical residence 112). In some embodiments, the tracking server(s) 102/residence tracking app may maintain the transaction(s) of a user in the residence profile of the user, such as via a list of transactions in memory or in a database of the tracking server(s) 102. The method may include additional, less, or alternate actions, including those discussed elsewhere herein.

### Exemplary Infinity Home Platform

In one aspect, an entity may provide an “infinity home platform” or IHP, such as by implementing the residential provisioning platform 100 of FIG. 1 using a residence provisioning app discussed above. As used herein, the term IHP platform is used interchangeably with the term residence provisioning platform (e.g., the residence provisioning platform 100). The entity deploying the IHP may (i) own real estate, such as homes, apartments, or condos, nationwide; (ii) manage mutual funds (or platform units) or stocks; and/or (iii) serve as the property, investment and member benefits management company. The IHP may facilitate the entity providing the following services: investment advice; wealth management; home inventory; pain-free moving services; preventative home maintenance; home security; banking; access to other beneficial services and relationships; and/or other services, including those discussed elsewhere herein.

In some aspects, consumers may subscribe to the IHP by purchasing a monthly minimum value of IHP mutual fund shares (e.g., platform units), for example. This subscription may entitle members to: (1) residency in available properties that the IHP owns within its nationwide inventory; (2) pain-free moves between IHP platform residences anytime the residents choose, including complimentary home-finding access, an up-to-date home inventory of current property, and moving services to facilitate relocation between residences in the platform; (3) portable equity (e.g., portable member value) from mutual fund investments that compound in volume and interest over time; and/or (4) access to all other services and relationships available within the platform (and/or residence provisioning app).

As a result of the creation of this platform, the IHP may realize the following opportunities for the entity: (i) the IHP may collect compounding interest from monthly member investments, as well as commissions from the transfer or sale of shares (or platform units), and recaptures the expense of real estate purchases and accrues compounding revenue; (ii) the HP may provide property or home/renters insurance, and increase claims mitigation on properties in the platform (and/or residence provisioning app) because the properties may receive semi-annual professional inspection and maintenance on the elements which cause the most claims (roof, plumbing, sump pump, electrical, etc.); (iii) the IHP may also acquire valuable telematics, lifestyle, and customer data via consumer use of IHP membership (and/or residence provisioning or other mobile device app); and/or (iv) the IHP may passively capture revenue from members' use of other products that support members' lifestyle (e.g., homeowners or renters insurance, auto insurance, life insurance, other types of insurance, banking products (such as home, auto, or personal loans, or mutual fund or stock products)), as well as services and relationships available as part of the IHP membership.

The following is one example of an IHP revenue opportunity from one property after 30 years (or 360 periods (12 months a year)). The HP may purchase a home with a purchase price of $200,000. This may equate to $200,000/360 periods=$556.56/monthly payment. Member value of shares (or platform units) purchased may be: $275,000, which equals the $200,000 base value plus project taxes, e.g., $75,000. This $275,000 value then divided by the period(s) (e.g., 360) would yield a $763.89/monthly payment. And $763.89×360 periods at a conservative 5% return=$638,403. Additionally, the member value, once the current home loan is paid off, may yield mutual funds proceeds to be divided. For instance, in one embodiment, the $638,403 less the $200,000 (recapture of property purchase cost)=$438,403. In such an embodiment, the $438,403× a commission (e.g., 50%)=$219,201.50 portable member value that accrues to the user, and $219,201.50 IHP revenue that accrues to the IHP, where the total revenue is $419,201.50 conservatively.

Another exemplary IHP scenario may include a consumer moving between IHP properties or selling IHP shares (or platform units). If a consumer moves to another house in the platform (and/or residence provisioning app) or otherwise decides to sell after a number of periods (such as 100 periods) prior to 360 periods passing, the IHP home purchase price may be $200,000, yielding $200,000/360 periods=$556.56/month, and $556.56×100 periods=$55,656. Member value of shares (or platform units) purchased again may be $275,000 (base+project taxes)/360=$763.89, and $763.89×100 periods at a conservative 5% return=$94,917. The $94,917−$55,656=$39,261, and the $39,261×50% commission=$19,631 portable member value, and $19,631 IP revenue.

Another exemplary IHP scenario may also include portable value when moving between IHP properties. When a consumer moves to another house, the consumer value may also be transferred. This amount may be subtracted from the IHP total home cost formula. Using the above example as the starting model, the transferred portable value of IHP shares is $19,631, the value of the new home is $200,000, and the projected taxes over 30 years is $75,000. The Total Home Cost (i.e., $275,000) minus Value of Transferred Shares (i.e., $19,631) divided by 360 Periods then becomes the Member Monthly Minimum Investment Value: $275,000−$19,631=$255,369/360 periods=$709.36.

In one aspect, an IHP entity may own a nationwide platform of houses, apartments, condos, and communities. Consumers and IHP members may own IHP mutual funds shares (or platform units), which enable them to live in these residences and enjoy the benefits of the IHP. The IHP benefits may include the ability to move to any platform house at any time with the click of a button (such as via a residence provisioning app discussed above). This may provide the ability for a user to live in a home of their choice for as long as they want, but does not anchor them to the home and typical homeowner expenses if a career opportunity arises, or a life event occurs.

The IHP benefits may include pain-free moving services, which may coordinate a move date, complete home inventory, wrap, pack, and move a member's possessions from the current house to the new house. Members may simply arrive at the new house, and unpack and organize their new home.

The IHP benefits may also include free, semi-annual home inspection and maintenance. An IHP approved service may inspect the most common sources of home insurance claims, and repair, if needed, at no expense. The IP benefits may further include discounts on services such as home security, lawn care, telematics, estate planning, subscription, insurance, and/or other home services.

The IHP benefits may include the ability to make payments that act as a compounding investment asset. The Infinity Home Platform may use member payments to purchase mutual and other stock funds, and provide equity to the member at the sale or transfer of the funds. As a result of the foregoing, with the Infinity Home Platform, members can live wherever they want, whenever they want, and receive the equity they normally would receive as homeowners without having the maintenance of homeowners or the interest payments of home loans.

In one embodiment, consumers may join the HP by selecting a house, and agreeing to a contract to purchase a minimum amount of monthly IHP or other mutual fund shares (or platform units) for up to a certain time period(s) (e.g., 360 periods, or 30 years). Consumers may also join by selling their current home to the IHP, receiving mutual funds shares (or platform units) for the equity of that house, and signing a contract to purchase a minimum amount of shares (or platform units) per month for the time period (e.g., up to 360 periods) for a new house selected.

In another embodiment, the HP may have a mobile device/.com website (e.g., the residence tracking server(s) 102 and/or residence provisioning app as described herein) for online access to many residence types across the nation. Members may move to any residence at any time, signing a new contract for the new residence they move to. The HP may take care of home inventory, packing, and transporting to new location.

The members may use mobile or other Internet platforms (e.g., the residence tracking server(s) 102 and/or residence provisioning app as described herein) to gain access to: Current Contract and Payment Information/Due Date/Current Payoff Date; Shares Held and Value of Shares (or platform units); Investment Options (such as Traditional IRA, Roth IRA, other Mutual Funds or Investments); modules for purchasing, selling, or transferring shares (or platform units) and bank funds transfer; and/or a Residence Aggregator (showing home size, bed/baths, style, location, cost, walkability, school scores, crime, cost of living, etc.). The residences may include houses, condos, apartments, and communities nationwide. The mobile or internet platforms or apps may facilitate selection of a new residence and scheduling for a residence move; providing moving, maintenance, inventory, and other services; selecting or purchasing multiple product lines (such as home, renters, auto, life or health insurance; various financial products, such as mutual funds, banking products; other affinity products; home services; and/or subscription services); general account management and agent contact; estate management services; subscription management; and/or home services management.

The IHP, or associated entity, may own the residences, while members purchase and own shares (or platform units) in order to live in those residences, and receive services and discounts for home services attached to the membership. Such services and discounts for home services may include: semi-annual inspection and maintenance of items which cause a majority of insurance claims (roof/gutter, plumbing and plumbing accessory, sump pump, property drainage, electric wiring/outlet, fire prevention, etc.); pain-free moving services; home inventory services when moving; home security services; lawn services; home telematics; and/or estate planning services. Each of these services and discounts for a home services may be provided or facilitated by the IHP and/or associated website and app (e.g., the residence tracking server(s) 102 and/or residence provisioning app as described herein).

The residence cost/minimum share (or platform units) purchased may be determined in the following way. The IHP, or associated entity, may purchase a residence at, or below, market value. The average projected property tax over 30 years may be added to the amount. The resulting amount may be divided by 360 periods (12 months over 30 years), or another amount of periods, such as 120 or 180 periods for 10 or 15 years, respectively. That resulting amount may be the minimum value of IHP mutual funds shares (or platform units) which need to be purchased each month by the customer to live in the home selected. For instance, the IHP, or associated entity, may purchase a home for $200,000. The average projected property tax may be $2,500×30 years=$75,000, and $275,000 (total cost)/360 periods=$763.89. Thus, a minimum of $763.89 in IHP mutual funds (or platform units) must be purchased each month to fulfill the terms of the contract.

In one scenario, more shares (or platform units) may be purchased than the minimum to shorten the length of the contract. Once the contract is fulfilled, no more shares (or platform units) need to be purchased however, because the shares (or platform units) may act as an investment, and a member may choose to continue to add shares (or platform units). The member may receive 100% of the proceeds purchased after the contract has been completed. Also, shares (or platform units) purchased after contract completion may be used by the owner when moving toward another platform house which is more expensive.

The shares (or platform units) and value may be portable from residence to residence. For instance, a member may have a contract for $300,000 with taxes ($833 in shares (or platform units) per month) in Oregon. They are currently valued at $21,067 with 5% return over the last 24 periods. The member decides to move to Missouri into a home valued at $200,000 with taxes. In one embodiment, the New Home Value−Member Current Shares Value=New Home Cost, and the New Home Cost/360 Periods=Minimum New Mutual Fund Purchase per month. In this case, $200,000−$21,067=$178,933/360 periods=$497/mo.

With the IHP, consumers may sell shares (or platform units) at any time. When shares are sold, the IHP and the consumer may split the proceeds of the sale of shares (or platform units) minus the value of the residence purchase price up to that time. For example, IHP home purchase price may be $200,000, which yields $200,000/360 periods=$556.56/mo. The member value of shares purchased may be $275,000 (base+project taxes)/360=$763.89×360 periods at 5% return=$638,403. In one embodiment, the Member Value−Current Home Paid Off=Mutual Fund Proceeds to be Divided. For example, $638,403−$200,000=$438,403×50% commission=$219,201.50 each.

If only a fraction of shares (or platform units) are being sold, the current home pay off may be the amount of periods, such as 100 periods, it took to accrue the number of shares (or platform units). For instance, the IHP home purchase price may be $200,000, which may yield $200,000/360 periods=$556.56/mo., and $556.56×100 periods=$55,656. The member value of shares purchased may be $275,000 (base+project taxes)/360=$763.89×100 periods at 5% return=$94,917. And $94,917−$55,656=39,261×50% commission=$19,631 each.

The IHP may reserve the right to sell a house in the platform with adequate notice to the current platform member. At that time, the member must move to another platform house or purchase the house. The Infinity Home Platform benefits may cease for that residence upon current member move or sale date. The IHP may keep an adequate supply of houses by following market warming and cooling trends, and may adjust prices of residences in areas that are warming and cooling with respect to market conditions and/or prices.

If a consumer damages a residence, the IHP may recover the cost of damage from insurance held and after insurance, deduct remaining damage cost/value from shares the user currently holds. If a consumer wishes to alter/remodel/landscape the residence, the platform may act as an HOA to approve alterations and may give additional shares (or platform units) to the member as a credit for value added to the residence. The purchase of other IHP lines or services is not required to participate in the Infinity Home Platform, however home or renter's insurance of some type may be required.

The IHP, or associated entity, may purchase or partner with service providers for home or appliance maintenance; moving or home inventory services; home security; lawn care, management services; logistics; design, credit reporting; investment and banking; reinsurers; funding; corporate or personal tax; real estate services; and/or wealth management. The IHP may be associated with a mobile device application/platform (e.g., the residence tracking server(s) 102 and/or residence provisioning app as described herein) that displays, or provides access to, mutual fund shares and value; current contract values and conditions; investment options; payment options; residences available and their characteristics; home services available; moving options and services; other product lines; IHP account management; the IHP contract and associated options; estate management and planning; buying, selling, and transferring shares (or platform unit) options; banking; subscription management services; and/or a share (or platform unit) transfer calculator.

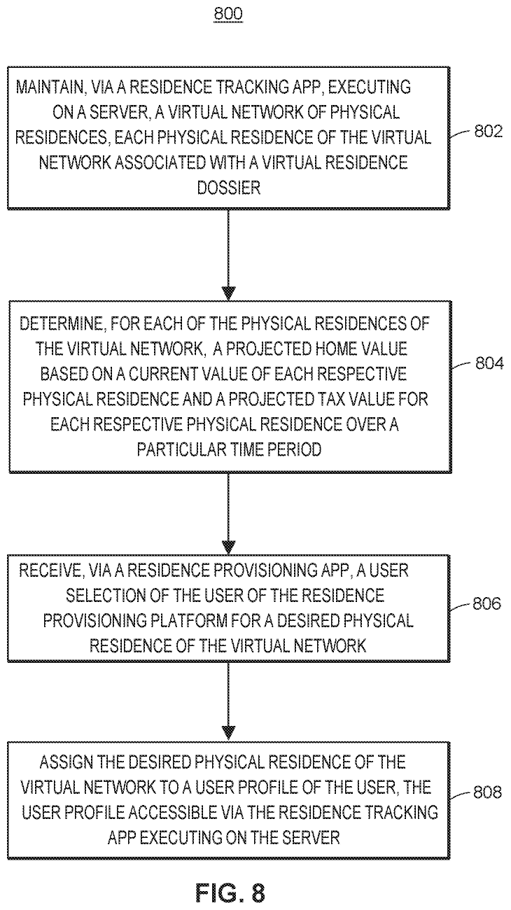

FIG. 8 depicts an embodiment of a computer-implemented method 800 for assigning projected home values to a plurality of corresponding physical residences and providing the plurality of physical residences via a residence provisioning platform for selection by a user of the residence provisioning platform. At block 802, the method 800 may include maintaining, via a residence tracking application (e.g., the residence tracking app as disclosed herein) executing on a server (e.g., the one or more residence tracking server(s) 102), a virtual network of physical residences. The virtual network of residences may be stored, for example, in one or more memories of the residence tracking server(s) 102, and may, in some embodiments, be stored in a relational database to manage the virtual network of residences and their related information and data as described herein. As described herein, each physical residence of the virtual network may be associated with a virtual residence dossier. In some embodiments, the virtual residence dossier may include neighborhood information for a neighborhood associated with a desired physical residence, a walkability score associated with the desired physical residence, or information regarding schools or churches in the vicinity of the desired physical residence.

At block 804, the residence tracking app may execute on the server to determine, for each of the physical residences of the virtual network, a projected home value. In various embodiments, the projected home value may be based upon a current value of each respective physical residence and a projected tax value for each respective physical residence over a particular time period. The projected home value of each physical residence may be stored and/or associated with each physical residence's respective virtual residence dossier, such as by storing and/or associating such information in a relational database of the residence tracking server(s) 102. In some embodiments, the current value of each respective physical residence may be a market value determined from a plurality of physical residences in a geographical area similar to each respective physical residence. In certain embodiments, the particular time period may be a 30 year time period.

At block 806, the residence tracking app may also receive, via a residence provisioning app (e.g., the residence provisioning app as disclosed herein), a user selection of the user of the residence provisioning platform for a desired physical residence of the virtual network. In one embodiment, the user, via the residence provisioning app executing on a mobile device (e.g., smart phone 136), may submit a virtual residence dossier over a computer network (e.g., computer network 120) for the user's existing physical residence. The submission may cause the residence tracking app to add the virtual residence dossier for the user's existing physical residence to the residence provisioning platform, e.g., such as the relational database. In certain embodiments, the desired physical residence is the user's existing physical residence. In still further embodiments, the user's selection may cause the residence tracking app to initiate a credit check on the user to determine whether the user had sufficient credit to participate in the residence provisioning platform (e.g., sufficient credit or assets to purchase enough platform units/shares as described herein).

In some embodiments, the desired physical residence may be displayed via the residence provisioning app with an option to view, via the residence provisioning app, the desired physical residence through one or more user experiences. For example, the user experiences could include one or more of a virtual or augmented reality experience, a video, one or more images, one or more 360 degree photos, or via a physical visit. The physical visit could be requested from the residence provisioning app to the residence tracking app in order to set up the physical visit for the user.

At block 808, the residence tracking app may assign the desired physical residence of the virtual network to a profile of the user. The profile may be stored and/or be made accessible via the residence tracking application (app) executing on the server, e.g., in the relational database. The relational database track, store, and associate the virtual dossier of the desired physical residence and the user's profile. The profile of the user may also include a platform unit balance that equals a projected home value of the desired physical residence of the virtual network. In some embodiments, the user profile may include a name of the user, an email address of the user, a phone number of the user, an address of the user, job information associated with the user, and a marital status associated with the user. In some embodiments, as described herein, a stakeholder may provide one or more services for at least a subset of the physical residences of the virtual network. For example, the one or more services may include any of physical residence maintenance, physical residence security, physical residence lawn care, or physical residence moving. The computer-implemented method for assigning projected home values to a plurality of corresponding physical residences and providing the plurality of physical residences via a residence provisioning platform for selection by a user of the residence provisioning platform, may include additional, less, or alternate actions, including those discussed elsewhere herein.

### Exemplary IHP Embodiments

The IHP may be setup by loading, or otherwise storing, information, including data, link, electronic addresses of resources, services, partners, etc., to be used by IHP platform in the memory of the IHP platform (e.g., such as one or more memories of the residence tracking server(s) 102 described herein). As describe herein the term IHP may refer interchangeably to the operator of the IHP platform and/or the IHP platform itself, e.g., the residence tracking server(s) 102 described herein. For example, the IHP may be associated with a mutual fund, which may be stored, setup, and/or tracked via the residence tracking server(s) 102. Additionally, for example, the IHP platform may load or store information or data regarding purchases and/or partners regarding maintenance, moving, inventory, home security, lawn care management services, logistics, design, credit reporting, investment and banking, reinsurers, funding partners, corporate and personal tax, real estate company, wealth management.

In various embodiments, the IP platform may be able to provide from the memory, e.g., over the computer network 120, information that may be accessed by a mobile device/mobile app, e.g., the residence provisioning app described herein. Such information may include, or be associated with, any of: mutual fund shares and/or value and tracking of such shares and/or value; current contract information; investment options; payment platform information or services; residences available; home services; moving platform; other product lines; IHP account management application; IHPL contact; estate management and planning; buy, sell, or transfer information; banking; subscriptions management services; and/or a transfer calculator tool.

In one IHP embodiment, the IHP (e.g., via the residence tracking server(s) 102 described herein) may provide advertising, marketing, and education to users. In other aspects, a user may locate the HP online, create a profile, select a house and view house details. The house details displayed by the IHP (or associated website or app) may include property value, monthly payment amount, and yearly taxes over 30 years (or another time period). The user may complete an online application process, via the HP, that includes credit and background check. The IHP may validate and approve (or deny) the application. The IHP may assign an IHP Liaison (IHPL) to a user. The IHPL may contact the platform member/user to discuss details of the IHP and mutual funds. The member/user may view the property, such as via virtual or augmented reality, video, images, 360 degree photos, or a physical visit. For example, the display of selections corresponding to a plurality of physical residences (as described herein) may include for at least one of the plurality of physical residences, an option to view, via the residence provisioning app, the at least one of the plurality of physical residences through one or more of a virtual or augmented reality experience, a video, one or more images, one or more 360 degree photos, or via a physical visit. The physical visit may be requested from the residence provisioning app to the residence tracking app.

The IHPL and member may execute a contract, and discuss moving details and subscription services. The IHP moving services may inventory belongings, wrap and pack home contents, and move the contents to a new platform home. Then, the management of the property may include a semi-annual maintenance check. The IHP may collect payments (e.g., auto draft, online and mobile platform, bank payment transfers). The IHP may continue to manage the platform and keep information up-to-date, and manage the relationship with the member, and pay any partner companies. This IHP embodiment may include additional, less, or alternate functionality, including that discussed elsewhere herein.

In another IHP embodiment, a user may be an existing homeowner user joining the platform (e.g., via the residence tracking server(s) 102 described herein). The user may go online to learn about the IHP, view a video on the program, read the benefits, and scroll through available platform houses. The house profile may include neighborhood information; a walkability score; information on schools, churches, restaurants, etc. The IHP may allow viewing of the houses through virtual reality, augmented reality, video, images, or 360 degree photos. For example, the display of selections corresponding to a plurality of physical residences (as described herein) may include for at least one of the plurality of physical residences, an option to view, via the residence provisioning app, the at least one of the plurality of physical residences through one or more of a virtual or augmented reality experience, a video, one or more images, one or more 360 degree photos, or via a physical visit. The physical visit may be requested from the residence provisioning app to the residence tracking app.

The IHP may provide an estimate of monthly cost (minimum share purchase per month, or minimum platform unit purchase per month) based upon current home value+projected tax for 30 years (or another time period, such as 15 years). The consumer may select a house via the IHP. After which, the IHP may ask the user to login or build a profile that contains name, email, phone, address, employment, marital status, and/or other user information. The user email and phone may be actively verified by the IHP.

Then the IHP may ask the user if he/she would like to move to the residence selected. If so, a current credit check may be performed. The user may submit a social security or other identifying number, and their marital and employment status. Instant approval or denial may be provided via the IHP, or through email. If approved, a customer service representative or agent member may contact the user to review their contract, walk them through the process, schedule their move, and answer any questions.

If the homeowner wants to sell their house to the IHP or associated entity, the homeowner may sell their house to the IHP to join the platform. Appraisals, inspections, and negotiation may follow, and ultimately, the IHP or associated entity may purchase the house. Then, the homeowner may receive equity in mutual funds shares. If the former homeowner wants to remain in the home, the remaining balance owed on the loan, if any, plus 30 years of projected taxes may be added, and that amount may be divided by 360 periods—the result is the minimum monthly amount of mutual funds to purchase to fulfill the contract.

A contract signing appointment may be scheduled. An agent member may welcome the new member, and then go over the details of the Infinity Home Platform and benefits. The agent member may then go over house details and answer any questions. The agent member may go over the details of the contract and minimum monthly mutual funds purchase. The user may sign in person, or digitally. Such appointments may be conducted in person, through a Skype type program (e.g., a voice or video based platform), or virtually. An agent member may also help the member schedule dates for home inventory, packing, and moving. After, the user/IHP member travels to the new location and moves in, the member may go to the Infinity Home Platform site, make electronic payments, and have access to their current share value, currently available homes within the platform, access to services and ability to make service requests, and much more. This IHP embodiment may include additional, less, or alternate functionality, including that discussed elsewhere herein.

In another IHP embodiment, a non-homeowner user may be joining the platform (e.g., via the residence tracking server(s) 102 described herein). The user may go online to learn about the IHP, view a video on the program, read the benefits, and scroll through available platform houses. The house profile may include neighborhood information; a walkability score; information on schools, churches, restaurants, etc. The IHP may allow viewing of houses through virtual reality, augmented reality, video, images, or 360 degree photos. For example, the display of selections corresponding to a plurality of physical residences (as described herein) may include for at least one of the plurality of physical residences, an option to view, via the residence provisioning app, the at least one of the plurality of physical residences through one or more of a virtual or augmented reality experience, a video, one or more images, one or more 360 degree photos, or via a physical visit. The physical visit may be requested from the residence provisioning app to the residence tracking app.

An estimate may be provided of monthly cost (minimum share purchase per month) based upon current home value+projected tax for 30 years (or another time period, such as 15 years). The user may select a house. After which, the IHP may ask the user to login or build a profile that contains name, email, phone, address, employment, marital status, and/or other information. The user email and phone may be actively verified by the IHP.

Then the IHP may ask the user if he/she would like to move to the residence selected. If so, a current credit check may be performed. The user may submit a social security or other identifying number, and their marital and employment status. Instant approval or denial may be provided via the IHP or through email. If approved, a customer service representative or agent member may contact the user to review their contract, walk them through the process, schedule their move, and answer any questions. The agent member may go over the details of the contract, and minimum monthly mutual funds (or platform units) purchase. The user may sign in person, or digitally. Such appointments may be conducted in person, through a Skype type program (e.g., a voice or video based platform), or virtually. An agent member may also help the member schedule dates for home inventory, packing, and moving. After, the user/IHP member travels to the new location and moves in, the member may go to the Infinity Home Platform site, make electronic payments, and have access to current share (or platform unit) value, currently available homes within the platform, access to services and ability to make service requests, and much more. This IHP embodiment may include additional, less, or alternate functionality, including that discussed elsewhere herein.

In one aspect, a computer-implemented method of using platform units (or shares) of a residence provisioning platform to allow users to move efficiently from one residence to another may be provided. The method may include (1) creating, via a residence tracking application (app) executing on a server, a virtual network of physical residences of the residential provisioning platform, the residence tracking app executing on a server to further: (a) create a virtual residence dossier for each physical residence of the virtual network of physical residences, (b) assign a platform unit value to each physical residences based upon each physical residences' virtual residence dossier, (c) receive a user selection of a user of the residence provisioning platform for a desired physical residence, (d) determine a minimum platform unit value associated with the desired physical residence, the minimum platform unit value equaling a residence platform unit value of the desired physical residence, and/or (e) transfer an existing platform unit value associated with an existing physical residence of the user to the desired physical residence, wherein the transfer causes a residence profile of the user to be updated such that the existing physical residence is disassociated from the user and the desired physical residence is associated with the user. The method may include additional, less, or alternate functionality, including that discussed elsewhere herein.

For instance, the residence platform unit value of the desired physical residence may be updated based upon current economic condition data. The current economic condition data may be used to train a machine learning model, the machine learning model executed to predict the residence platform unit value of the desired physical residence. The user may select to obtain the minimum platform unit value associated with the desired physical residence from the residence provisioning platform. The user may select one or more services from the residence provisioning platform.

The residence tracking app executing on a server may maintain a balance of platform units (or shares) of the user, the balance of platform units attributable to the desired physical residence. The balance of platform units of the user may cause the residence tracking app to generate an electronic schedule, the electronic schedule indicating a number of future platform units to be obtained by the user for the desired physical residence. The number of future platform units may be scheduled periodically, such as weekly or monthly.

The transfer may cause the existing platform value of the user to be credited to the residence profile of the user, and the transfer may cause the residence platform unit value of the desired physical residence to be debited from the residence profile of the user. The virtual network of physical residences may include physical residences indicated as available for immediate occupancy. Each virtual residence dossier may be stored in a database of the server, and/or may include residence characteristics including location, square footage, number of bedrooms, walkability, number of bathrooms, and/or other characteristics, including those discussed elsewhere herein.

The user selection may be received from a residence provisioning app executing on a user device. The server may maintain one or more transactions associated with the transfer.

In another aspect, a computer-implemented method of using platform units (or other shares) of a residence provisioning platform to allow users to move efficiently from one residence to another may be provided. The method may include (1) maintaining, via a residence tracking application (app) executing on a server, an existing balance of platform units in a residence profile of a user of the provisioning platform, wherein the residence profile identifies an existing physical residence of the user, and wherein the existing balance of platform units are associated with the existing physical residence; and/or (2) maintaining, via the residence tracking app executing on the server, a virtual network of physical residences, each physical residence of the virtual network associated with a virtual residence dossier, the residence tracking app executing on a server to further: (a) receive a user selection of the user of the residence provisioning platform for a desired physical residence of the virtual network, (b) determine a minimum platform unit value associated with the desired physical residence, the minimum platform unit value equaling a residence platform unit value of the desired physical residence, and/or (c) transfer the existing balance of platform units to the desired physical residence, wherein the transfer causes the existing balance of platform units to become associated with the desired physical residence, and wherein the transfer causes the residence profile of the user to be updated such that the existing physical residence is disassociated from the user and the desired physical residence is associated with the user. The residence platform unit (or other share) value of the desired physical residence may be updated based upon current economic condition data. The current economic condition data may be used to train a machine learning model or algorithm (such as a deep, combined, or reinforced learning module or algorithm), the machine learning model executed to predict the residence platform unit value of the desired physical residence. The method may include additional, less, or alternate actions, including those discussed elsewhere herein.

In another aspect, a computer-implemented method is disclosed for assigning projected home values to a plurality of corresponding physical residences and providing the plurality of physical residences via a residence provisioning platform for selection by a user of the residence provisioning platform. The method may include (1) maintaining, via a residence tracking application (e.g., the residence tracking app as disclosed herein) executing on a server (e.g., the one or more residence tracking server(s) 102), a virtual network of physical residences. Each physical residence of the virtual network may be associated with a virtual residence dossier. In some embodiments, the virtual residence dossier may include at least one of neighborhood information for a neighborhood associated with a desired physical residence, a walkability score associated with the desired physical residence, or information regarding schools or churches in the vicinity of the desired physical residence.

The residence tracking app may execute on the server to (a) determine, for each of the physical residences of the virtual network, a projected home value. The projected home value may be based upon a current value of each respective physical residence and a projected tax value for each respective physical residence over a particular time period. In some embodiments, the current value of each respective physical residence may be a market value determined from a plurality of physical residences in a geographical area similar to each respective physical residence. In certain embodiments, the particular time period may be a 30 year time period.

The residence tracking app may also (b) receive, via a residence provisioning app (e.g., the residence provisioning app as disclosed herein), a user selection of the user of the residence provisioning platform for a desired physical residence of the virtual network. In one embodiment, the user, via the residence provisioning app, may submit a virtual residence dossier for the user's existing physical residence. This may cause the residence tracking app to add the virtual residence dossier for the user's existing physical residence to the residence provisioning platform. In certain embodiments, the desired physical residence is the user's existing physical residence. In still further embodiments, the user's selection may cause the residence tracking app to initiate a credit check on the user.

In some embodiments, the desired physical residence may be displayed via the residence provisioning app with an option to view, via the residence provisioning app, the desired physical residence through one or more user experiences. For example, the user experiences could include one or more of a virtual or augmented reality experience, a video, one or more images, one or more 360 degree photos, or via a physical visit. The physical visit could be requested from the residence provisioning app to the residence tracking app in order to set up the physical visit for the user.

The residence tracking app may also (c) assign the desired physical residence of the virtual network to a profile of the user. The profile may be stored and/or be made accessible via the residence tracking application (app) executing on the server. The profile of the user may also include a platform unit balance that equals a projected home value of the desired physical residence of the virtual network. In some embodiments, the user profile may include a name of the user, an email address of the user, a phone number of the user, an address of the user, job information associated with the user, and a marital status associated with the user.

In some embodiments, as described herein, a stakeholder provides one or more services for at least a subset of the physical residences of the virtual network. For example, the one or more services may include any of physical residence maintenance, physical residence security, physical residence lawn care, or physical residence moving.

The computer-implemented method for assigning projected home values to a plurality of corresponding physical residences and providing the plurality of physical residences via a residence provisioning platform for selection by a user of the residence provisioning platform, may include additional, less, or alternate actions, including those discussed elsewhere herein.

### Additional Considerations

Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of exemplary computer-implemented methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but also deployed across a number of machines. In some example embodiments, the processor or processors may be located in a single location, while in other embodiments the processors may be distributed across a number of locations.

The performance of certain of the operations may be distributed among the one or more processors, not only residing within a single machine, but also deployed across a number of machines. In some exemplary embodiments, the one or more processors or processor-implemented modules may be located in a single geographic location (e.g., within a home environment, an office environment, or a server farm). In other embodiments, the one or more processors or processor-implemented modules may be distributed across a number of geographic locations.

This detailed description is to be construed as exemplary only and does not describe every possible embodiment, as describing every possible embodiment would be impractical, if not impossible. One may be implement numerous alternate embodiments, using either current technology or technology developed after the filing date of this application.

Those of ordinary skill in the art will recognize that a wide variety of modifications, alterations, and combinations may be made with respect to the above described embodiments without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

1. A computer-implemented method of using platform units of a residence provisioning platform to allow users to move efficiently from one residence to another, the method comprising:
maintaining, via a residence tracking application (app) executing on a server, an existing balance of platform units in a residence profile of a user of the provisioning platform, wherein the residence profile identifies an existing physical residence of the user, and wherein the existing balance of platform units are associated with the existing physical residence and are unique to the residential provisioning platform; and
maintaining, via the residence tracking app executing on the server, a virtual network of physical residences, each physical residence of the virtual network associated with a virtual residence dossier and having an assigned residence platform unit value unique to the residential provisioning platform, the residence tracking app executing on a server to further:
receive a user selection of the user of the residence provisioning platform for a desired physical residence of the virtual network;
determine a minimum platform unit value associated with the desired physical residence, the minimum platform unit value being less than a residence platform unit value of the desired physical residence;
provide, in response to a determination that the minimum platform unit value exceeds the existing balance of platform units, an option for the user to purchase a number of additional platform units to reach the minimum platform unit value; and
transfer, in response to a determination that the existing balance of platform units equals or is greater than the minimum platform unit value, the existing balance of platform units to the desired physical residence, wherein the transfer causes the existing balance of platform units to become associated with the desired physical residence, and wherein the transfer causes the residence profile of the user to be updated such that the existing physical residence is disassociated from the user and the desired physical residence is associated with the user.

2. The computer-implemented method of claim 1, wherein the residence platform unit value of the desired physical residence is updated based upon current economic condition data.

3. The computer-implemented method of claim 2, wherein the current economic condition data is used to train a machine learning model, the machine learning model executed to predict the residence platform unit value of the desired physical residence.

4. The computer-implemented method of claim 1, wherein the user selects to obtain the minimum platform unit value associated with the desired physical residence from the residence provisioning platform.

5. The computer-implemented method of claim 1, wherein the user selects one or more services from the residence provisioning platform.

6. The computer-implemented method of claim 1, wherein the residence tracking app executing on a server updates the platform unit value of the platform units of the user during a period after the transfer.

7. The computer-implemented method of claim 6, wherein the transfer causes the residence tracking app to generate an electronic schedule, the electronic schedule indicating a number of future platform units to be obtained by the user for the desired physical residence.

8. The computer-implemented method of claim 7, wherein the number of future platform units is scheduled monthly.

9. The computer-implemented method of claim 1, wherein the transfer causes the existing platform value of the user to be credited to the residence profile of the user, and wherein the transfer causes the minimum platform unit value of the desired physical residence to be debited from the residence profile of the user.

10. The computer-implemented method of claim 1, wherein the virtual network of physical residences includes physical residences indicated as available for immediate occupancy.

11. A residence provisioning system configured to provide platform units of a residence provisioning platform to allow users to move efficiently from one residence to another, the residence provisioning system comprising:
a server including one or more processors; and
a residence tracking application (app) configured to execute on the one or more processors of the server, the residence tracking app further configured to maintain an existing balance of platform units in a residence profile of a user of the provisioning platform, wherein the residence profile identifies an existing physical residence of the user, and wherein the existing balance of platform units are associated with the existing physical residence and are unique to the residential provisioning platform,
the residence tracking app further configured to maintain a virtual network of physical residences, each physical residence of the virtual network associated with a virtual residence dossier and having an assigned residence platform unit value unique to the residential provisioning platform, and
the residence tracking app further configured to:
receive a user selection of the user of the residence provisioning platform for a desired physical residence of the virtual network,
determine a minimum platform unit value associated with the desired physical residence, the minimum platform unit value being less than a residence platform unit value of the desired physical residence,
provide, in response to a determination that the minimum platform unit value exceeds the existing balance of platform units, an option for the user to purchase a number of additional platform units to reach the minimum platform unit value, and
transfer, in response to a determination that the existing balance of platform units equals or is greater than the minimum platform unit value, the existing balance of platform units to the desired physical residence, wherein the transfer causes the existing balance of platform units to become associated with the desired physical residence, and wherein the transfer causes the residence profile of the user to be updated such that the existing physical residence is disassociated from the user and the desired physical residence is associated with the user.

12. The residence provisioning system of claim 11, wherein the user selects to obtain the minimum platform unit value associated with the desired physical residence from the residence provisioning platform.

13. The residence provisioning system of claim 11, wherein the transfer causes the existing platform value of the user to be credited to the residence profile of the user, and wherein the transfer causes the minimum platform unit value of the desired physical residence to be debited from the residence profile of the user

14. The residence provisioning system of claim 11, wherein the virtual network of physical residences includes physical residences indicated as available for immediate occupancy.

15. The residence provisioning system of claim 11, wherein each virtual residence dossier is stored in a database of the server.

16. The residence provisioning system of claim 11, wherein each virtual residence dossier includes residence characteristics including location, square footage, number of bedrooms, and number of bathrooms.

17. The residence provisioning system of claim 11, wherein the user selection is received from a residence provisioning app executing on a user device.

18. The residence provisioning system of claim 11, wherein the server maintains one or more transactions associated with the transfer.

19. The residence provisioning system of claim 11, wherein determining the residence platform unit value of the desired physical residence includes determining a projected physical residence value, the projected physical residence value based upon a current value of the desired physical residence and a projected tax value of the desired physical residence over a certain time period.

20. The residence provisioning system of claim 11, wherein the desired physical residence is displayed via a residence provisioning app with an option to view, via the residence provisioning app, the desired physical residence through one or more of: a virtual or augmented reality experience, a video, one or more images, one or more 360 degree photos, or via a physical visit, the physical visit requested from the residence provisioning app to the residence tracking app.
